(19) United States
(12) Patent Application Publication
(10) Pub. No.: US 2025/0351242 A1
(43) Pub. Date: Nov. 13, 2025

(54) CALIBRATION DEVICE FOR LUMINAIRE

(71) Applicant: LEDVANCE LLC, WILMINGTON, MA (US)

(72) Inventors: Tianzheng Jiang, Shenzhen (CN); Wuqiang Liao, Shenzhen (CN); Ming Li, Acton, MA (US)

(21) Appl. No.: 19/204,046

(22) Filed: May 9, 2025

Related U.S. Application Data
(60) Provisional application No. 63/645,491, filed on May 10, 2024.

(51) Int. Cl. H05B 45/12; H05B 47/19

(52) U.S. Cl. CPC H05B 45/12; H05B 47/19

(57) ABSTRACT

A calibration system that includes a light detector for reading lighting characteristics of a lighting structure; a receiver for interfacing with driver electronics for controlling current to a light engine of a lighting structure; and a controller. The controller is for receiving readings from the light detector for the lighting characteristics of the lighting structure, comparing the light characteristics to a reference light characteristic value, and sending an adjustment signal to the receiver by a wireless signal. The adjustment signal can include a current change to the light engine for adjusting the lighting characteristics towards the reference light characteristic value.

### CROSS REFERENCE TO RELATED APPLICATIONS

This application claims the benefit of U.S. Provisional Application No. 63/645,491 filed May 10, 2024, titled “CALIBRATION DEVICE FOR LUMINAIRE”.

### TECHNICAL FIELD

The present disclosure generally relates to luminaires. More particularly, the present disclosure is directed to methods, systems and computer program products that can be used to set the light settings of components within a luminaire.

### BACKGROUND

Repair and replacement of driver electronics for lighting structures may require that the new components for the repair need to be configured to provide the desired lighting characteristics for the light being emitted by the lighting structure. For example, when replacing components in a lighting structure, the user may wish for the repaired lighting structure to emit light having lighting characteristics that were the same as the light before the repair was performed. The driver electronics are one component in a lighting structure that impacts the lighting characteristics for the light being emitted by the light engine. Therefore, when the user wants to emulate the lighting characteristics of the lighting structure from before the repair in the repaired device, the repaired device should use the same electrical performance from the driver electronics. However, the user does not always know the electrical performance of the driver electronics prior to the repair of the lighting structure. The electrical performance of the driver electronics can include the current value, and optical parameters of lighting structure. This can especially be the case when the lighting structure emits light having a corelated color temperature (CCT) and illuminance produced by a mixture of warm white and cool white light emitting diodes (LEDs). In this instance, there can be two current channels for both warm white and cool white light emitting diodes (LEDs). This can complicate configuring the driver electronics.

For example, for an only one channel luminaire whose CCT does not dim, the driver product label will provide information on the output current. In this example, the user can choose a replacement driver that has the same current and equal or higher power output to the original driver that is being replaced. However, for lighting structures including multichannel driver electronics, e.g., driver electronics using two channels, there is no practical, mature solution, users can know the current in each channel. In this instance, users are not able to retrieve the light settings from the individual channels of the driver electronics for the lighting structure, such as the color correlated temperature (CCT) and illuminance.

### SUMMARY

The present disclosure provides methods and structures for adjusting lighting characteristics. In some embodiments, a calibration system is provided. In some embodiments, the calibration system may include a light detector for reading lighting characteristics of a lighting structure; and a receiver for interfacing with driver electronics for controlling current to a light engine of a lighting structure. In some embodiments, the calibration system can also include a controller for receiving readings from the light detector for the lighting characteristics of the lighting structure, comparing the light characteristics to a reference light characteristic value, and sending an adjustment signal to the receiver by a wireless signal. The adjustment signal including a current change to the light engine for adjusting the lighting characteristics towards the reference light characteristic value.

In an embodiment, the controller is a mobile computing device. For example, the controller may be a cellular phone, such as a smart phone. In some embodiments, when the controller is a mobile computing device, the lighting characteristics measured by the lighting detector is sent to the controller by a first wireless signal, and the wireless signal by which the controller sends the adjustment signal to the receiver is a second wireless signal.

In some embodiments, the driver electronics include at least two channels to at least two strings of light emitting diodes in the light engine. In some embodiments, the driver electronics include an interface to at least two DIM+connectors on the driver electronics. In this example, the receiver receives the adjustment signal from the controller, and the adjustment signal includes commands to adjust current to the at least two channels to the at least two stings of light emitting diodes through the at least two DIM+connectors. In some embodiments, the lighting structure of the calibrations system has a form factor selected from the group consisting of a luminaire, tube lamp, downlight, lamp bulb and combinations thereof. In some embodiments, the at least one of the first wireless signal and the second wireless signal being employed by the calibration system is selected from the group consisting of a WiFi signal, a cellular signal, a near field communication (NFC) signal, a Bluetooth type signal and combinations thereof.

In another aspect, a method of calibrating light is provided. The method of calibrating light can include setting a reference light characteristic value; and connecting a receiver to driver electronics of a lighting structure including an adjustable light engine. The method for calibrating light can further include measuring lighting characteristics from the lighting structure with a light detector to provide an initial lighting value; and comparing the initial lighting value to the reference light characteristic value using a controller that correlates lighting characteristics to driver electronic electrical performance. The controller provides an adjustment setting in the driver electrical performance to compensate for differences between the reference light characteristic value and the initial lighting value; and sending the adjustment signal from the controller to the receiver. The method can further include adjusting light emitted by the lighting structure to correspond to the adjustment signal received at the receiver. In an embodiment, the controller is a mobile computing device. In another embodiment, the controller is integrated into the light detector. In some embodiments, the driver electronics include at least two channels to at least two strings of light emitting diodes in the light engine. In some embodiments, the adjusting of the light emitted by the light structure includes adjusting current to the at least two channels of the at least two strings of light emitting diodes in the light engine. In some embodiments, the driver electronics include an interface to the at least two DIM+connectors on the driver electronics, the connecting of the receiver to the driver electronics includes connecting the receiver to the at least two DIM+connectors. In some embodiments, the adjusting of the current to the at least two channels of the at least two strings of light emitting diodes in the light engine can include adjusting the current through the at least two DIM+connectors. In some embodiments, the reference light characteristic value is a measured light characteristic selected from the group consisting of color correlated temperature (CCT), illumination (LUX) and combinations thereof. In some embodiments, the detector is selected from the group consisting of tristimulus colorimeter, a spectroradiometer, a spectrophotometer, a spectrocolorimeter, a densitometer, a color temperature meter and combinations thereof. In some embodiments, the reference light characteristic value is measured from an operating light.

In yet another aspect, a computer program product is provided for calibrating lighting. In one embodiment, the computer program product includes a computer readable storage medium having program instructions embodied therewith, the program instructions executable by a processor to cause the processor to perform instructions including setting a reference light characteristic value; receiving lighting characteristics from a light detector measuring a lighting structure provide an initial lighting value; and comparing the initial lighting value to the reference light characteristic value using a controller that correlates lighting characteristics to driver electronic electrical performance. In some embodiments, the controller provides an adjustment setting for the driver electrical performance to compensate for differences between the reference light characteristic value and the initial lighting value. In some embodiments, the compute program product can further send an adjustment signal from the controller to a receiver connected to driver electronics controlling a light engine of the light structure. Thereafter, the light emitted by the lightings structure can be adjusted to correspond to the adjustment signal received at the receiver.

### BRIEF DESCRIPTION OF THE DRAWINGS

The following description will provide details of embodiments with reference to the following figures wherein:

FIG. 1 is an illustration of a calibration device for determining the electrical performance of driver electronics in lighting structures, in accordance with an embodiment of the present disclosure.

FIG. 2 is an illustration of an electronics driver including ports for interfacing with the calibration device, in accordance with an embodiment of the present disclosure.

FIG. 3 is an illustration of an calibration device for determining the electrical performance of driver electronics in lighting structures, in accordance with an embodiment of the present disclosure.

FIG. 4 is a block/flow diagram that illustrates a method of using the calibration device to characterize driver electronic electrical performance for producing lighting characteristics for light emitted from a luminaire, in accordance with one embodiment of the present disclosure.’

FIG. 5 is an illustration of a detector for use with the calibration device depicted in FIG. 1, in accordance with an embodiment of the present disclosure.

FIG. 6 is an illustration of an calibration device that works in combination with a mobile computing device for determining the electrical performance of driver electronics in lighting structures, in accordance with an embodiment of the present disclosure

FIG. 7 is a block diagram of a mobile computing device for controlling the calibration device for determining the electrical performance of driver electronics in lighting structures, in accordance with an embodiment of the present disclosure.

FIG. 8 is a table illustrating mixing of two strings of light emitting diodes having two different color correlated temperatures, in accordance with an embodiment of the present disclosure.

FIG. 9 is a circuit diagram of the multi-channel driver electronics of a lighting structure, in accordance with an embodiment of the present disclosure.

FIG. 10 is a top down view of a light engine including a plurality of solid state light emitters providing the light source of a lamp that includes two strings of light emitting didoes (LEDs) to provide at least two lighting schemes for a light engine as employed in the luminaire lamp illustrated in FIGS. 1 and 6, in accordance with an embodiment of the present disclosure.

FIG. 11A is a perspective front view of a sensor for the calibration device, in accordance with an embodiment of the present invention.

FIG. 11B is a perspective side view of the sensor for the calibration device, in accordance with an embodiment of the present invention.

FIG. 12A is a perspective front view of a receiver for the calibration device, in accordance with an embodiment of the present invention.

FIG. 12B is a perspective back view of the receiver for the calibration device, in accordance with an embodiment of the present invention.

FIG. 13 is a screen shot of the controller for operating the calibration device, in accordance with an embodiment of the present invention.

### DETAILED DESCRIPTION

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

Repair and replacement of driver electronics for lighting structures may require that the new components for the repair need to be configured to provide the desired lighting. The structures and methods of the present disclosure can allow for a user to detect values from driver electronic components.

Prior to the methods and structures of the present disclosure, other efforts made to change the lamp and driver output have been largely unsuccessful. One practice is to use a smart driver, such as a driver that includes an integrated Bluetooth, WiFi or Zigbee transceiver. This would require a built in smart chip/module and an antenna for communication. In this type of arrangement, when users connect the driver to a lighting structure, they can then use an application, i.e., software, to adjust the diming performance, color correlated temperature (CCT) characteristics and illuminance characteristics of the lighting structure. The user can then put a illuminometer under the lighting structure. Thereafter, users need to observe the difference between the value of the illuminometer and the reference light characteristic value, and then the user can make many continuous adjustments on the application in an effort to get the light characteristics being emitted from the lighting structure including the new driver electronics to match a reference light characteristic value. This is not an economic solution. Further, it can take a long time and can take many adjustments, to match the reference light characteristic value. In this procedure, the user does not know the exact current value for the driver applications. Therefore, the users can not copy to the current values from the original driver electronics of the light structure to another light structure. Without actually knowing the electrical characteristics of the driver electronics, it can be very difficult to replace driver electronics and achieve the same lighting characteristics

Another possibility for discovering the settings of driver electronics for replacement by servicing is to measure the current value from a normally working luminaire. For example, a clip-on ammeter can be used to test each channel current from a normal working luminaire. The current value for each channel can be recorded. The current values can then be copied to the replacement driver electronics of the lighting structure by wireless or wired connection to the driver.

The negative aspects of these methods are clear. For example, the user needs a working luminaire in each of the aforementioned methods in order to measure the current being applied by the driver electronics to the light engine. Further, in each instance, the user may have to disassemble the working normal luminaire to measure the current. In the aforementioned methods, if the user only has the driver broken luminaries, there is no way to measure the electrical performance of the driver.

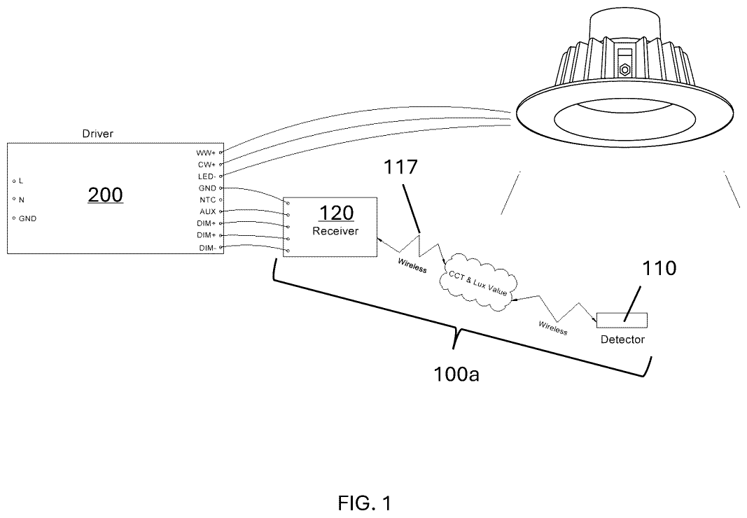

The structures and methods of the present structure provide a solution to at least the aforementioned difficulties. In some embodiments, to solve the aforementioned difficulties in configuring driver electronics, the methods and structures described herein provide a calibration device for setting the electrical settings of the driver electronics for the lighting structures. The calibration device described herein can easily detect the current value of driver electronics. In some embodiments, the calibration device describe herein can precisely measure current values from driver electronics for light structures. Having precise current values for the driver electronics, the calibration device can then exactly copy these optical parameters, e.g., current applied to the different strings of LEDs in the light engine by the driver electronics, to the new driver electronics in the repaired light structure. By providing the ability to exactly copy the current values from the driver electronics, the calibration device makes it substantially easier for the user to know the current values from an existing lighting structure, and then use those current values for copying to a new lighting structure, e.g., copying to the driver electronics of a new lighting structure. The structures and methods of the present disclosure are now described with greater detail with reference to FIGS. 1-13.

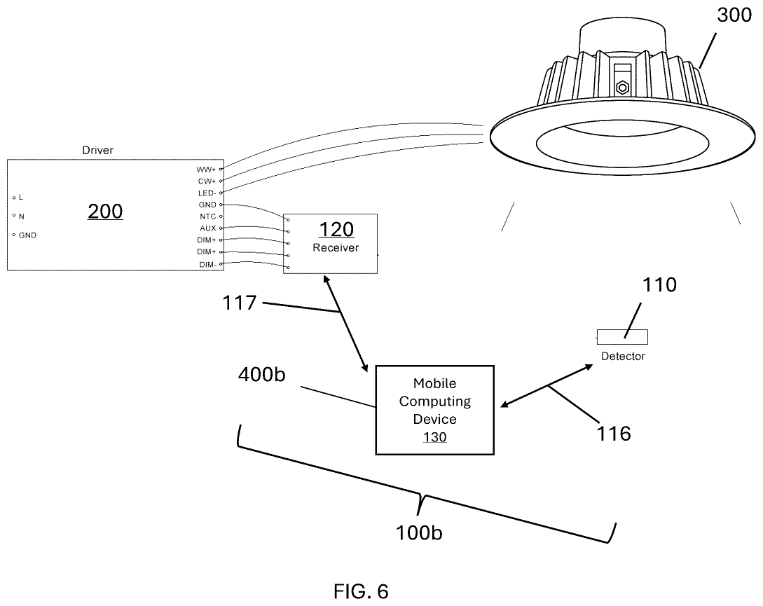

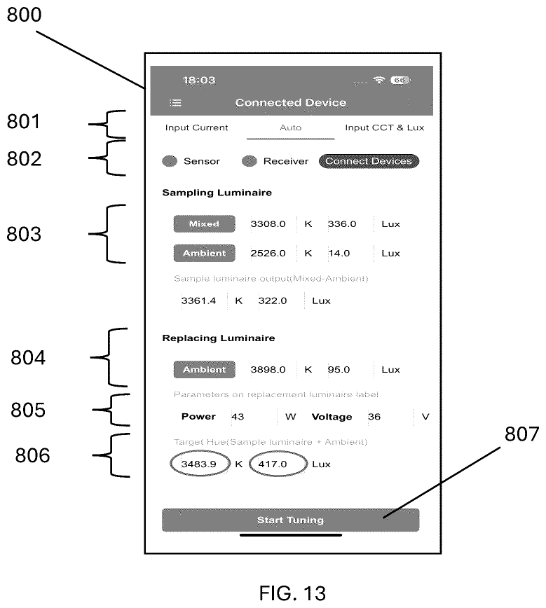

FIGS. 1 and 6 are illustrations of a calibration device 100a, 100b for determining and setting the electrical performance for the driver electronics 200 of lighting structures 300, in accordance with an embodiment of the present disclosure. In some embodiments, the driver electronics 200 for the lighting structures 300 that are measured and/or configured by the calibration device 100a, 100b may be two channel (2Ch) near field communication (NFC) constant current light emitting diode (LED) drivers. The two channel (2Ch) near field communication (NFC) constant current light emitting diode (LED) drivers may be driver components that are external drivers from the housing of the lighting structure 300 that houses the light engine of the lighting structure 300. In some embodiments, the driver electronics 200 for the lighting structures 300 can be configured manually by the user using the calibration device 100a, 100b inputting the lighting characteristic requirements for the lighting structures 300 being configures into the calibration device 100a,100b. FIG. 13 illustrates one embodiment of a screenshot of a user interface 800 of a control device 400a, 400b through which a user can manually enter input current for the driver electronics at mode select field 801 of the user interface 800 of the controller 400a, 400b. The user may also manually enter lighting characteristics, such as input color correlated temperature (CCT) and Lux, at the mode select field 801 of the user interface 800 of the controller 400a, 400b. In some embodiments, when a sample lighting structure (e.g., sample luminaire/sample driver electronics) is available, the calibration device 100a, 100b can extract lighting characteristic data from the sample lighting structure (e.g., sample luminaire/sample driver electronics), and then use those extracted lighting characteristics from the sample lighting structure for configuring new driver electronics 200 and/or new lighting structures 300 for commissioning into a lighting environment, in which it is desired for the new driver electronics 200 and/or new lighting structure 300 to emit light having the same lighting characteristics as the light emitted by the sample lighting structure (e.g., sample luminaire/sample driver). The ability of the calibration device 100a, 100b to measure the lighting characteristics of the sample lighting structure (e.g., sample luminaire/sample driver electronics) and then use that data to configure a newly commissioned lighting structure 300/newly commissioned driver electronics 300 to produce light having the same characteristics as the sample lighting structure (e.g., sample luminaire/sample driver electronics) may be referred to as a “self-calibration” or “auto” feature of the calibration device 100a, 100b. Referring to FIG. 13, the user can select this mode of operation for the calibration device 100a, 100b by selecting the “auto” mode from the mode select field 801 of the user interface 800 of the controller 400a, 400b.

In some embodiments, the calibration device 100a, 100b that is part of a calibration system that may include a light detector 110 for reading lighting characteristics of a lighting structure 300; and a receiver 120 for interfacing with driver electronics 200 for controlling current to a light engine 310 of a lighting structure 300. In some embodiments, when using the “self-calibration” or “auto” feature of the calibration device 100a, 100b, the sample lighting structure (e.g., sample luminaire/sample driver electronics) may be in the same area as the light detector 110, and while the receiver 120 is connected to this powered sample lighting structure, (e.g., sample luminaire/sample driver electronics). The calibration device 100a, 100b including the detector 110 and the receiver 120 may function in combination with a controller 400a, 400b including a set of instructions to extract data. The controller 400a, 400b is wirelessly connected to the receiver 120, and the receiver 120 is electrically connected to the driver electronics 200. The detector 110 may also be wirelessly connected to the controller 400a, 400b. FIG. 13 is a screen shot of a user interface 800 through which the status of connectivity between the controller 400a, 400b, the detector 110 and the receiver 120 is provided by a connected device field 802.

For example, the detector 110 and/or controller 400a, 400b may analyze the actual output lighting parameters (“mixed” lighting−“ambient” lighting=Sample Luminaire Output). Referring to FIG. 13, the sampling luminaire field 803 of the user interface 800 of the controller 400a, 400b includes the mixed lighting data and the ambient lighting data. The sample luminaire output is displayed in the sample luminaire output/missed-ambient field 804 of the user interface 800 of the controller 400a, 400b.

In some embodiments, the calibration system can also include a controller 400a, 400b. In the embodiments consistent with FIG. 1, the controller 400a of the calibration device 100a may be integrated into the light detector 110. In some embodiments, when using the “self-calibration” or “auto” feature of the calibration device 100a, 100b, the calibration device 100a, 100b including the detector 110 and the receiver 120 may function in combination with the controller 400a, 400b including a set of instructions to extract data. For example, the detector 110 may analyze the actual output lighting parameters (“mixed” lighting−“ambient” lighting=Sample Luminaire Output).

In the embodiments consistent with FIG. 6, the controller 400b of the calibration device 100b may be integrated into a mobile computing device 130, which may be a phone, such as a cellular phone. The cellular phone may include one or more microprocessors to provide a smart phone. The smart phone may also include memory for storing one or more applications with instruction sets to be executed by the one or more microprocessors for performing functionality of the calibration system. For example, the controller 400b may be provided by an app (i.e., application) that is present in the memory of the smart phone.

In some embodiments, the controller 400a, 400b is for receiving readings from the light detector 110 for the lighting characteristics of the lighting structure 300, comparing the light characteristics to a reference light characteristic value, and sending an adjustment signal to the receiver 120 by wireless signal 117. The adjustment signal including a current change to the light engine 310 for adjusting the lighting characteristics towards the reference light characteristic value.

As used herein, the term “lighting structure” can be used to refer to a luminaire, a lamp, a bulb or any structure including a light engine for illuminating a space, e.g., building space. Referring to FIGS. 1 and 6, the lighting structure 300 is depicted as having a luminaire form factor, e.g., is a recessed down can luminaire. In this example, in which the housing has the geometry of a recessed downlight, the recessed downlight having a diameter selected from the group consisting of 3 inch, 4 inch, 5 inch, 6 inch, 8 inch, 9 inch, 10 inch, and 12 inch.

It is noted that luminaires represent only one type of form factor that may be used with the methods and structures of the present disclosure. For example, the lighting structure can be have a tube lamp form factor. For example, the lighting structure can be used for T8 and/or T12 lamp sizes, but any other lamp size can be employed with the calibration device 100 that is the subject of the present disclosure. For example, T2, T4, T6, T9, T10, T12, T17 and PG17 may also used. For example, the tube lamps described here may employ a G13 socket, but this is only one embodiment of the present disclosure and is not intended to be limiting. Additionally, the structures described herein are scalable. For example, the lamp designs described herein can be adapted for either 2′, 3′, 4′ or 8′ lamp sizes.

Any form factor for a lighting structure employing driver electronics may be suitable for the methods and structures of the present invention.

The calibration device 100a, 100b can automatically correct the power supply current for the driver electronics 200 of the lighting structure 300. The calibration device 100a, 100b can include a detector 110 and a receiver 120.

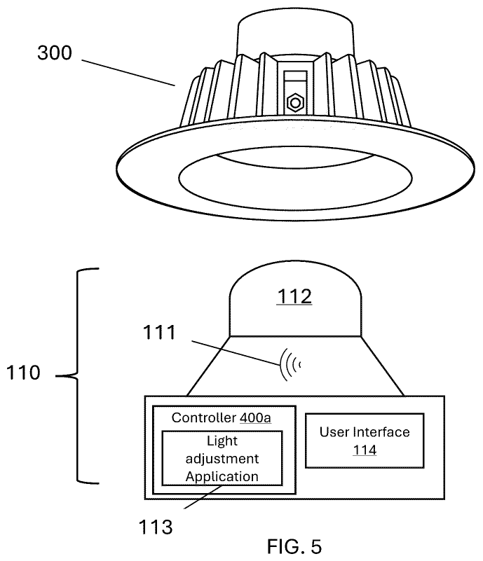

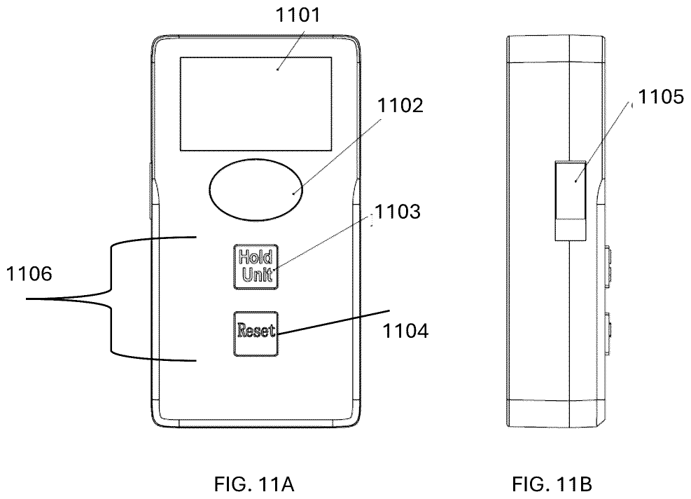

FIGS. 5, 11A and 11B illustrate some embodiments of a light detector 110 for reading lighting characteristics of a lighting structure 300. The light detector 110 can measure the color correlated temperature (CCT) of the light being emitted by the lighting structure 300. “Correlated color temperature (CCT)” is a measure of the “color” of a light source, expressed in Kelvin (K). It corresponds to the temperature of an ideal black body that would emit light of a similar “color.” CCT is measured on a scale from 1,000 to 10,000 K. Different colors of light can impact our mood and behavior. Correlated color temperature (CCT) is a measure of the “color” of a light source, expressed in Kelvin (K). It corresponds to the temperature of an ideal black body that would emit light of a similar “color.” CCT is measured on a scale from 1,000 to 10,000 K.

The Color Temperature Scale is a way of measuring the color of light. It is measured in Kelvins (K), and it is a scale from red to blue. The lower the Kelvin value, the more red the light is. The higher the Kelvin value, the more blue the light is.

To measure color temperatures, the detector 110 may be a colorimeter, which analyzes white light and separates it into constituent colors. Each of these colors is then assigned a corresponding value on the Kelvin scale.

CCT values of the environment can also be measured precisely with spectroradiometers being employed for the detector 110, which aim to precisely measure radiance, luminance and chromaticity of light. Additionally, CCT values can be estimated with lower accuracy using various color space transformations and predefined models instead of spectroradiometer devices.

In some other embodiments, the detector 110 may be provided by colorimetric equipment that is similar to that used in spectrophotometry. For example, the detector 110 can be, or can include a tristimulus colorimeter, a spectroradiometer, a spectrophotometer, a spectrocolorimeter, a densitometer, a color temperature meter or a combination thereof. A tristimulus colorimeter measures the tristimulus values of a color. A spectroradiometer measures the absolute spectral radiance (intensity) or irradiance of a light source. A spectrophotometer measures the spectral reflectance, transmittance, or relative irradiance of a color sample. A spectrocolorimeter is a spectrophotometer that can calculate tristimulus values. A densitometer measures the degree of light passing through or reflected by a subject. A color temperature meter measures the color temperature of an incident illuminant.

In one example, the detector 110 may be a color temperature meter. In some examples, internally the meter for a color temperature meter that is provided by a detector 110 is a silicon photodiode tristimulus colorimeter. The correlated color temperature can be calculated from the tristimulus values by first calculating the chromaticity co-ordinates in the CIE 1960 color space, then finding the closest point on the Planckian locus.

It is noted that the above examples of types of detectors for use as the detector 110 of the calibration device 100a, 100b is provided for illustrative purposes only, and it is not intended that the present disclosure be limited to only this example. Other examples of detectors not specifically listed may be employed with the calibration device 100, so long as the detector can be used to determine the color correlated temperature (CCT) of the lighting structure 300.

It is noted that the detector 110 also measures the lux characteristics of light being emitted by the luminaire 300. Lux is a unit of light measurement where the area is also taken into account. 1 lux equals 1 Lumen/m², in other words-light intensity in a specific area. Lux is used to measure the amount of light output in a given area. One lux is equal to one lumen per square meter. The lux characteristics of light being emitted by the luminaire 300 may be measured by a detector 110 that can be or can include a Lux meter/lumen meter.

To detect the light characteristics, such as the color correlated temperature (CCT), of the light being emitted by the lighting structure 300, the detector 110 is positioned within the beams of light being emitted by the lighting structure 300. In some embodiments, a lux meter works by using a photo cell to capture light. The meter then converts this light to an electrical current, and measuring this current allows the device to calculate the lux value of the light it captured.

FIG. 5 is an illustration of one embodiment of a detector 110 for use with calibration device 100 depicted in FIG. 1, in accordance with an embodiment of the present disclosure. The detector 110 depicted in FIG. 5 may also be used for the calibration device 100 depicted in FIG. 6, so long as the controller 400b aspect of the system is provided by a mobile computing device 400b in the embodiment that is depicted in FIG. 6. The detector 110 includes a light sensing element 112, in which the light sensing element 112 may be configured to provide any of the aforementioned type light detectors. The detector 110 also includes an antenna 111. The antenna 111 may be a transceiver, but also may be a combinations of receiver and transmitters. The antenna 111 provides for communication between the detector 110 and the receiver 120 depicted in the system 100 of FIG. 1. The antenna 11 provides for communication between the detector 110 and the mobile computing device 130, e.g., a smartphone. The antenna 111 can also provide for communication with the mobile computing device 130, such as a cellular phone, e.g., smart phone, in which commands can be transmitted between the mobile computing device 130, the detector 110 and the receiver 120.

FIGS. 11A and 11B illustrate one embodiment of a detector 110 for use with the calibration device 100a, 100b. The detector 110 may include a screen 1101 through which the detector 110 can provide information to the user. The information displayed on the screen 1101 may be the characteristics of light being measured by the detector 110. In other embodiments, the information being displayed on the screen 1101 may be instructions on how the user can use the detector 110 as a component of the calibration device 100 in setting up lighting structures 300. In some embodiments, the information displayed on the screen 1101 may be status of the detector 110, e.g., status of the detector 110 in a process sequence that measures and configures lighting characteristics for lighting structures 300 using the calibration device 100a, 100b.

Still referring to FIG. 11A, as described above, the detector 110 also includes a light sensing element 112. The light sensing element 112 has been described above for measuring a number of different types of lighting characteristics. For example, in one embodiment, the light sensing element 112 of the detector 110 measures lux characteristics of light being emitted by the luminaire 300 that can range from 0.001 lux to 300 K lux.

In some embodiments, the housing the of the detector 110 may include an opening with a transparent window 1102. For example, the transparent window 1102 may be plastic and/or glass, or may just be an opening through the body of the housing for the detector 110. The material/medium of the transparent window 1102 is selected to ensure that light transmitted by the lighting structures 300 that is being measured by the detector 110 travels through the transparent window 1102 and reaching the sensing element 112 that may be positioned within the housing of the detector 110. In some embodiments, when the detector 110 reading the lighting characteristics of a lighting structure 300, the detector 110 is positioned so that the transparent window 1102 faces the light being emitted by the lighting structure 300.

As illustrated in FIGS. 11A and 11B, the detector 1102 may include a user interface 1106. The user interface 1106 can include a hold unit button 1103, a reset button 1104 and a power (ON/OFF) button 1105.

The hold unit button 1103 and the reset button 1104 of the detector 110 can be used when the calibration device 100a, 100b is configured for calibrating the lighting structure 300/driver electronics 200 of a newly commissioned device using the when using the “self-calibration” or “auto” feature of the calibration device 100a, 100b. For example, the hold unit button 1103 may be selected by the user to cause the detector 110 to record a measurement of the light, e.g., measure of the light characteristics, being taken from the lighting structure 300. In some embodiments, the hold unit button 1103 when pressed by the user causes a lighting measurement to be performed by the detector 110, which can be saved in memory of the detector 110. The detector 110 can send a wireless signal. For example, as will be described below, a first wireless signal 116 and/or second wireless signal 117 can sent between the mobile computing device 130 and the receiver 120 connected to the driver electronics 200 and/or the detector 110 making measurements of the light being emitted by the lighting structure 300. The hold unit button 1103 when activated can start the process of measuring the lighting characteristics of the lighting structure 300 using the detector 110, whereas pressing the reset button 1104 can restart the process and/or clear the memory of the detector 110.

In some embodiments, the detector 110 may be powered using a battery power source, e.g., the detector 110 may be powered by two AA batteries. To save battery power, the detector 110 includes a power (ON/OFF) button 1105.

In some embodiments, the detector 110 may be used when a sample luminaire is available to record lighting characteristics from for emulating the same lighting characteristics into lighting structures 300 being newly commissioned into a lighting application, such as a room being luminated or a network of existing lighting structures. As will be described below, the calibration device 100a, 100b may include a self-calibration setting, e.g., “auto” setting, for extracting that data for the sample luminaire, e.g., sample lighting structure, where the new replacement driver (for replacement lighting structure) will be used.

The self-calibration setting replicates the lighting parameters of the “sample” luminaire, e.g., sample lighting structure, onto the newly commissioned electronics driver 200, which may be an element of a newly commissioned lighting structure 300, e.g., newly commissioned luminaire. In some embodiments, the newly commissioned electronics driver 200 for the newly commissioned lighting structure (newly commissioned luminaire) can have the same output luminance and CCT potential as the sample lighting structure, and the sample lighting structure and the newly commissioned lighting structure 300 are in a same common area.

For example, the detector 110 when in the same area as the sample luminaire, and while the receiver 120 is connected to driver electronics 200 of the sample luminaire that is powered ON to emit light, the detector 110 in combination with the controller 400 extracts lighting characteristic data from the sample luminaire. In some embodiments, the detector 110 collects ambient data from the replacement unit area with the sample luminaire powered OFF. For example, the meter/sensor will analyze the actual output lighting parameters (“mixed” lighting−“ambient” lighting=Sample Luminaire Output). In some embodiments, the controller 400 and/or the detector 110 can then have data for the Target Hue formula (sample luminaire output+replacement luminaire ambient).

FIG. 13 is a screen shot of a user interface 800 through which a user can run the calibration device 100a, 100b from the controller 400a, 400b, in which a target hue (sample luminaire and ambient) field is illustrated by reference number 807. In some embodiments, the luminaire parameters, e.g., the luminaire parameters from the Target Hue formula are manually entered into the controller 400, and the controller 400 can start tuning and adjusting the newly commissioned driver electronics/newly commissioned lighting structure according to the controller having the parameters from the above described Target Hue formula. The manually entered luminaire parameters may be entered into the user interface 800 of the controller in the parameters of replacement luminaire label field 806. The newly commissioned driver electronics 200 are then customized and ready for use. The replacing luminaire field 805 of the user interface 800 of the controller 400a, 400b depicted in FIG. 13 illustrates the performance of the luminaire customized through the newly commissioned driver electronics. Once this is completed, the controller 400a, 400b can be detached and used for another occasion.

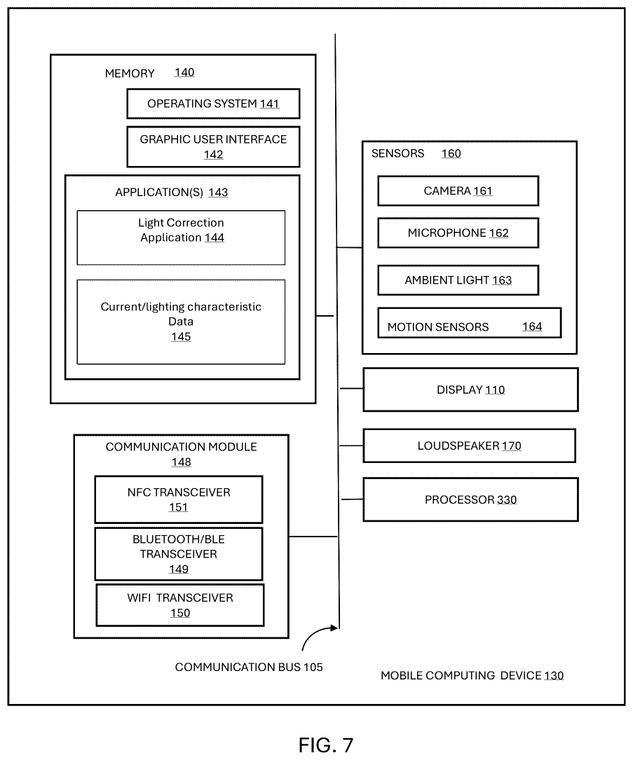

FIG. 6 is an illustration of a calibration device 100b that works in combination with a mobile computing device 130 for determining the electrical performance of driver electronics 200 in lighting structures 300, in accordance with an embodiment of the present disclosure. FIG. 7 is a block diagram of a mobile computing device 130 for controlling the calibration device 110 for determining the electrical performance of driver electronics 200 in lighting structures 300, in accordance with one embodiment of the present disclosure.

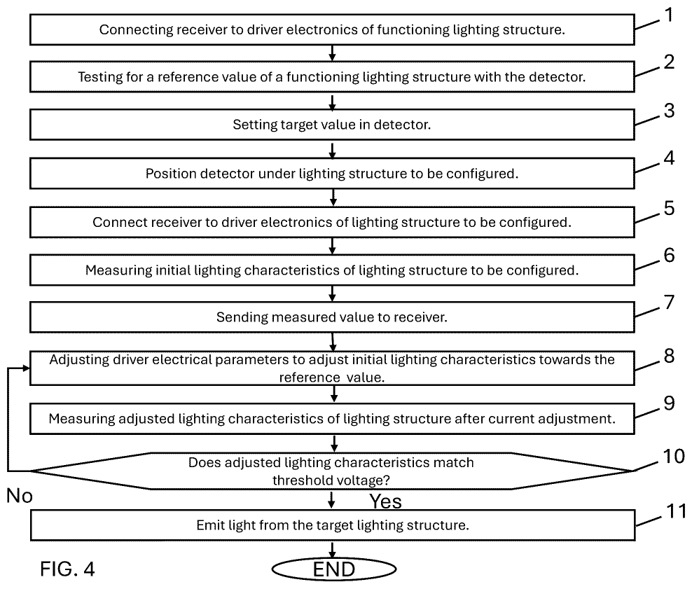

As will be described in greater detail below, in some embodiments, a mobile computing device 130, such as a cellular phone, e.g., smart phone, may be used for the user interface, e.g., graphic user interface 142, through which the user can operate the calibration device 100b. In this instance, an application 143, such as a light calibration application 144, installed on the memory 140 of the mobile computing device 130 may include a set of instructions for implementation using at least one hardware processor, e.g., processor 330, of the mobile computing device 130 to provide wireless signal commands and/or transmissions received and/or sent between the mobile computing device 130, the receiver 120 and the detector 110 for performing at least some of the steps of the method described below with reference to FIG. 4. In some examples, the mobile computing device 130, e.g., a cellular phone, such as a smart phone, may include a communication module 148 for sending and/or receiving signal transmissions, such as commands between the mobile computing device 130 and the receiver 120 connected to the driver electronics 200 and/or the detector 110. The communication module 148 can include an NFC transceiver 151, a Bluetooth/BLE transceiver 149 and a WiFi transceiver 150. Each of these transceivers may be used for wireless signal, e.g., first wireless signal 116 and/or second wireless signal 117, between the mobile computing device 130 and the receiver 120 connected to the driver electronics 200 and/or the detector 110 making measurements of the light being emitted by the lighting structure 300.

However, in some embodiments, the mobile computing device 130 may be omitted. In some embodiments, the detector 110 may be configured to include a built in controller 400a, which can include a light adjustment application 113, as depicted in FIG. 5

Referring to FIGS. 1, 2 and 6, the calibration device 100a, 100b can also includes a receiver 120 that may be directly wired to the driver electronics 200 of the lighting structure 300. In the embodiment depicted in FIG. 1, the receiver 120 can communicate with the detector 110 wirelessly. In the embodiment depicted in FIG. 6, the receiver 120 can communicate with at least one of the mobile computing device 130 and/or the detector 110.

In some embodiments, the detector 110 and the receiver 120 and the mobile computing device 130 may each wirelessly communicate using WiFi signal, near field communication (NFC) signal, Bluetooth (BLE) signal or a combination thereof. “Near Field Communication” (NFC) is a short-range wireless technology that enables simple and secure communication between electronic devices. It may be used on its own or in combination with other wireless technologies, such as Bluetooth. The communication range of NFC is roughly 10 centimeters. However, an antenna may be used to extended the range up to 20 centimeters. NFC is a wireless signal. NFC works on the principle of sending information over radio waves. Near Field Communication (NFC) is a standard for wireless data transitions. This means that devices adhere to certain specifications in order to communicate with each other properly. The technology used in NFC is based on RFID (Radio-frequency identification), which use electromagnetic induction in order to transmit information. NFC can be used to induce electric currents within passive components as well as just send data. This means that passive devices don't require their own power supply. They can instead be powered by the electromagnetic field produced by an active NFC component when it comes into range. The transmission frequency for data across NFC is 13.56 megahertz. In some embodiments, can send data at either 106, 212, or 424 kilobits per second.

Bluetooth signal may be sent using Bluetooth Classic radio or Bluetooth Low Energy (BLE). The Bluetooth Classic radio, also referred to as Bluetooth Basic Rate/Enhanced Data Rate (BR/EDR), is a low power radio that streams data over 79 channels in the 2.4 GHz unlicensed industrial, scientific, and medical (ISM) frequency band. Bluetooth Classic supports point-to-point device communication.

Bluetooth Low Energy (LE) radio is designed for very low power operation. Transmitting data over 40 channels in the 2.4 GHz unlicensed ISM frequency band, the Bluetooth LE radio provides developers a tremendous amount of flexibility to build products that meet the unique connectivity requirements of their market. Bluetooth LE supports multiple communication topologies, expanding from point-to-point to broadcast and mesh, enabling Bluetooth technology to support the creation of reliable, large-scale device networks.

Bluetooth low energy (BLE) is generally packaged with Bluetooth classic. BLE can be found in a majority of smart terminal devices generally beginning with the inception of BLE. If a smart lighting device has BLE designed into it, it can be controlled by smart terminal devices of the same generation directly. BLE can provide for a direct “point to point” connection between a mobile computing device, or other end user terminal device, and controllable peripheral devices, such as lamps.

In some other embodiments, the wireless capabilities employed through the communication module can be WiFi based. For example, the WiFi transmission can be based upon IEEE 802.11, which is for wireless LANs (WLANs), also known as Wi-Fi. The 802.15 group of standards specifies a variety of wireless personal area networks (WPANs) for different applications. For instance, 802.15.1 is Bluetooth, 802.15.3 is a high-data-rate category for ultra-wideband (UWB) technologies, and 802.15.6 is for body area networks (BAN). The 802.15.4 category is probably the largest standard for low-data-rate WPANs. It has many subcategories. The 802.15.4 category was developed for low-data-rate monitor and control applications and extended-life low-power-consumption uses. The basic standard with the most recent updates and enhancements is 802.15.4a/b, with 802.15.4c for China, 802.15.4d for Japan, 802.15.4e for industrial applications, 802.15.4f for active (battery powered) radio-frequency identification (RFID) uses, and 802.15.4g for smart utility networks (SUNs) for monitoring the Smart Grid. All of these special versions use the same base radio technology and protocol as defined in 802.15.4a/b.

Whether the communication standard is Bluetooth, WiFi and/of NFC, the receiver 120 and the detector 110 have the appropriate antennae through which communication via the selected signal type can be used to transmit data between the detector 110 and the receiver 120. The antennae may be configured as transmitters, receivers and/or transceivers. In some embodiments, the receiver 120 may be connected to the driver electronics 200 as illustrated in FIG. 1.

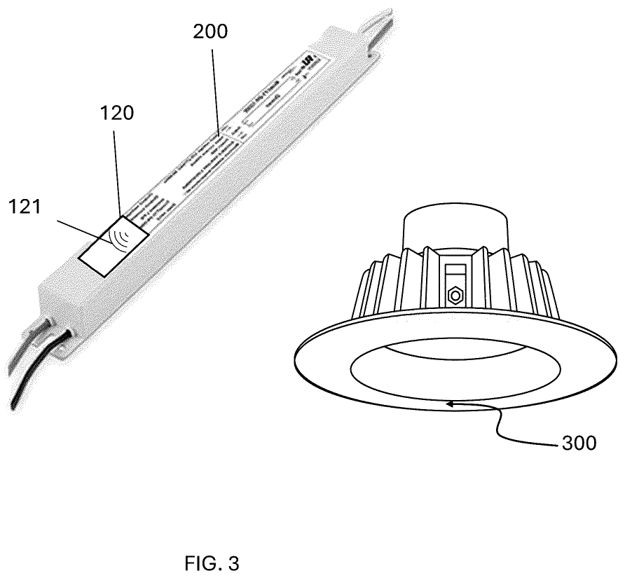

FIG. 3 illustrates another view of a luminaire 300 and its driver electronics 200 that are present in an external housing, i.e., the housing for the driver electronics 200 is separate from the luminaire 300. In some embodiments, the driver electronics 200 for the lighting structures 300 that are measured and/or configured by the calibration device 100a, 100b may be two channel (2Ch) near field communication (NFC) constant current light emitting diode (LED) drivers. In some embodiments, the driver electronics 200 may be near field communication (NFC) enabled programmable constant current 2 channel light emitting diode drier that can be a linear type and have models for 120V-347V. The driver electronics 200 may be field programmable. The driver electronics can receive light characteristics settings from mobile devices that provide the controller 400a, 400b using near field communication (NFC) signal. For example, the driver electronics 200 can include their own independent near field communication (NFC) transceiver 121. The independent NFC transceiver 121 of the driver electronics 200 is separate from any transceiver 121 and/or signal receiving document of the receiver 140. The independent NFC transceiver 121 of the driver electronics 200 may receive data sent by NFC signal transmission from the controller 400a, 400b, which may be a mobile computing device 130, such as a smart phone. For example, the independent NFC transceiver 121 provides another mechanism by which the electrical characteristics of driver electronics that have been determined to provide specific lighting characteristics by the calibration device 100a, 100b described herein can be transmitted between the mobile device 130, e.g., controller 400b, and driver electronics 200 that are being newly commissioned. This type of data transfer may include brining the mobile device 130 and the driver electronics 200 within close proximity to one another, e.g., by tapping them together, in order to send data by NFC signal between the independent NFC transceiver 121 of the driver electronics 200 and the NFC transceiver 151 of the mobile computing device 131.

In some embodiments, the two channel (2Ch) near field communication (NFC) constant current light emitting diode (LED) drivers may include two channel outputs that are independent of one another without interference. They two channel (2Ch) near field communication (NFC) constant current light emitting diode (LED) drivers are field programmable using NFC communication. In some embodiments, the programming that allows for the two channel (2Ch) near field communication (NFC) constant current light emitting diode (LED) drivers to be field programmable does not require that the driver be powered up. In some embodiments, the two channel (2Ch) near field communication (NFC) constant current light emitting diode (LED) drivers may be customized (programmed) according to current (mA) per each independent channel. In some embodiments, the two channel (2Ch) near field communication (NFC) constant current light emitting diode (LED) drivers may be customized (programmed) according to Dim-to-Off performance and/or Dim %. In some embodiments, the two channel (2Ch) near field communication (NFC) constant current light emitting diode (LED) drivers may be customized (programmed) according to constant lumen output. In some embodiments, the two channel (2Ch) near field communication (NFC) constant current light emitting diode (LED) drivers may be customized (programmed) according to Aux voltage. In some embodiments, the two channel (2Ch) near field communication (NFC) constant current light emitting diode (LED) drivers may be customized (programmed) according to soft start performance. In some embodiments, the two channel (2Ch) near field communication (NFC) constant current light emitting diode (LED) drivers may be customized (programmed) according to end of life performance. In some embodiments, the two channel (2Ch) near field communication (NFC) constant current light emitting diode (LED) drivers may be customized (programmed) according to thermal protection performance.

In some embodiments, the two channel (2Ch) near field communication (NFC) constant current light emitting diode (LED) drivers have an output wattage ranging from 55 w to 85 w. In some embodiments, the two channel (2Ch) near field communication (NFC) constant current light emitting diode (LED) drivers have an output wattage ranging from 55 w to 85 w. In some embodiments, the output current range of the two channel (2Ch) near field communication (NFC) light emitting diode (LED) drivers may range from 140 mA to 2300 mA. For example, a two channel (2Ch) near field communication (NFC) constant current light emitting diode (LED) drivers having an output wattage of 55 w may have an output current ranging from 140 mA to 1400 mA. For example, a two channel (2Ch) near field communication (NFC) constant current light emitting diode (LED) drivers having an output wattage of 85 w may have an output current ranging from 230 mA to 2300 mA.

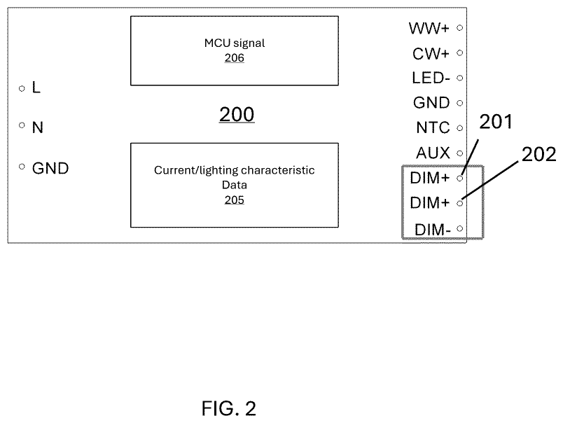

FIG. 2 illustrates one embodiment of the type of connections for the driver electronics 200 to the lighting structure 300. The driver electronics 200 can include two dimming ports, i.e., DIM+ports having reference numbers 201 and 202. The driver electronics 200 also include a DIM−port identified by reference number 203. The DIM+ports and the DIM−ports may be used during configuration of the driver electronics 200 to signal changes for the current applied to the driver electronics to be ramped up or ramped down, in response to measurement by the detector 110. For example, if the detector 110 measures light that is at a color correlated temperature (CCT) value that is higher or lower than the reference CCT value, the detector 110 may send a signal to the receiver that the CCT is too high, and provide instructions to the receiver to adjust the current to each of the different strings of light emitting diodes (LEDs). The receiver 120 is electrically connected to the DIM+ and DIM−ports of the driver 200. After the driver electronics 200 have been configured to emit light from the light engine meeting the characteristics of the reference color correlated (CCT), the receiver 120 may be disconnected from the driver electronics 200. Once the receiver 120 is disconnected, the DIM+ and DIM−connections for the driver electronics 200 can be used for the dimming functions of the lighting structure 300.

In some embodiments, when a user connects the driver 200 to a luminaire 300 as depicted in FIG. 1, the user also connects the receiver 120 to the driver electronics 200. Referring to FIGS. 1 and 3, the ports designated AUX (auxiliary) and GND (ground) on the driver electronics 200 provide electrical power for powering the receiver 120, and are wired accordingly. Each of the DIM+port and DIM−port provides an electrical circuit between the driver electronics 200 and the receiver 120. In the example depicted in FIGS. 1 and 3, there are two DIM+ports identified by reference numbers 201 and 202. This provides two electrical circuits. The two electrical circuits connected to the DIM+ports can transmit control information to the driver electronics 200. In an embodiment, one is for CCT dimming information, another is for illuminance information.

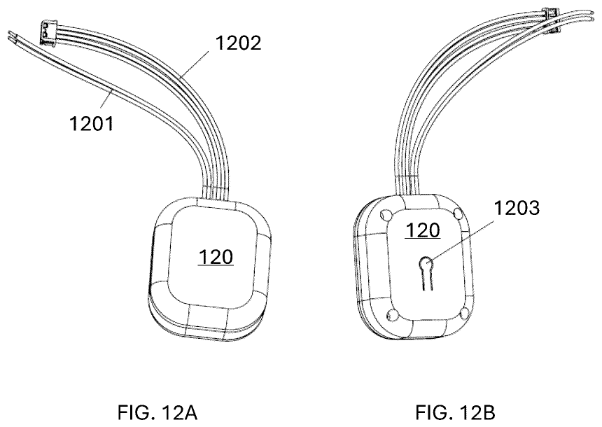

FIGS. 12A and 12B illustrate one embodiment of a receiver 120 for use with the calibration device 100a, 100b. The receiver 120 may include a power cable 1201 for powering the receiver 120 while interfacing with the driver electronics 200 of the lighting structures 300, and a control cable 1202, e.g., serial cable, for controlling the driver electronics 200 using signal from the controller 400a, 400b to adjust the electrical output of the driver electronics 200. By adjusting the electrical output of the driver electronics 200, the light emitted by the lighting structure 300 is modulated for measurement by the detector 110. In some embodiments, electrical output of the driver electronics 200 may be adjusted by adjusting the current output of the driver electronics 200. In other embodiments, electrical output of the driver electronics 200 may be adjusted through Pulse Width Modulation (PW M). Pulse Width Modulation (PWM) is a technique used to control the brightness of LEDs by varying the percentage of time the LED is on versus off in a single cycle. This method simulates different brightness levels, enabling both dimming and color mixing with RGB LEDs. PWM works by adjusting the duty cycle, which is the ratio of the time the LED is on to the total cycle time. A higher duty cycle means the LED is on for a longer portion of the cycle, resulting in a brighter appearance. Conversely, a lower duty cycle makes the LED dimmer. By independently controlling the brightness of each color with PWM, a wide range of colors can be created by mixing the individual colors in different proportions. Each color channel (red, green, blue) can be controlled by a separate PWM signal, allowing for precise color adjustments.

During this cycling of electrical performance by the driver electronics 200 controlled by controller 400a, 400b through the receiver 120, and the measurement of the resultant lighting characteristics emitted by the lighting structure 300 connected to the driver electronics 200 as recorded by the detector 110; electrical performance from the output of the driver electronics 200 are be correlated to lighting characteristics. This information is all made available to the controller 400a, 400b, which can be made available to the user.

As illustrated in FIG. 2. 12B, the receiver 120 may also include a user interface, e.g., reset 1203. Pressing the reset button 1104 can restart the calibration process of the calibration device 100a, 100b. The reset button 1104 may also provide for connectivity to the control device 400a, 400b.

In some embodiments, the receiver 120 may be powered through the power cable 1201 that connects to the driver electronics 200. For example, the power cable 1201 may engage a 12V power supply that is provided by the driver electronics 200. In some other embodiments, the receiver 120 may be powered using a battery power source.

In some embodiments, the receiver 120 works in combination with the detector 110 and the controller 400a, 400b as part of a self-calibration or auto mode of operation for the calibration device 100a, 100b when the driver electronics of a sample luminaire is available to record electrical characteristics from. For example, during the self-calibration or auto mode of operation for the calibration device 100a, 100b, in addition to the lighting characteristics being recorded from the sample lighting structure by the detector 110, the electrical characteristics for providing those lighting characteristics can be determined using the receiver 120. In the instances when a new replacement driver (for replacement lighting structure) will be used, that data recorded using the detector 110, receiver 120 and controller 400a, 400b may then be used for emulating the same lighting characteristics into driver electronics 200 being newly commissioned for newly commissioned lighting structures 300.

The self-calibration setting replicates the lighting parameters of the “sample” luminaire, e.g., sample lighting structure, onto the newly commissioned electronics driver 200, which may be an element of a newly commissioned lighting structure 300, e.g., newly commissioned luminaire. For example, the controller 400a, 400b may provide an adjustment setting in the driver electrical performance to compensate for differences between the reference light characteristic value and the initial lighting value; and sending the adjustment signal from the controller 110 to the receiver 120. In some embodiments, light emitted by the lighting structure 300 corresponding the adjustment signal received at the receiver 120 from the controller 400a, 400b are recorded by the detector 110.

FIG. 4 is a block/flow diagram that illustrates a method of using calibration device to characterize driver electronic electrical performance for producing lighting characteristics for light emitted from a luminaire, in accordance with one embodiment of the present disclosure.

It is noted that the methods of the present disclosure are not limited to only those depicted in FIG. 4. For example, additional initial steps before the process flow specifically depicted in FIG. 4 may also be employed by the method. Further, intermediate steps may be practiced between those that are specifically depicted in FIG. 4. Finally, there may be additional steps for the method following those specifically depicted.

It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium, which can be non-transitory, that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). The module, segment or portion of instructions may be saved on a form of memory, i.e., hardware memory. A hardware processor may be employed to execute the one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Broadly, the method for calibrating light may include setting a reference light characteristic value; and connecting a receiver 120 to driver electronics 200 of a lighting structure 300 including an adjustable light engine 310. The method for calibrating light can further include measuring lighting characteristics from the lighting structure 300 with a light detector 110 to provide an initial lighting value; and comparing the initial lighting value to the reference light characteristic value using a controller 400a, 400b that correlates lighting characteristics to driver electronic electrical performance. The controller 400a, 400b provides an adjustment setting in the driver electrical performance to compensate for differences between the reference light characteristic value and the initial lighting value; and sending the adjustment signal from the controller 110 to the receiver 120. The method can further include adjusting light emitted by the lighting structure 300 to correspond to the adjustment signal received at the receiver 120. In an embodiment, the controller 400b is a mobile computing device 130, as depicted by FIG. 6.

FIG. 13 illustrates one embodiment of a screen shot of a controller 400a, 400b, in which the calibration may be initiated by the user by selecting the start tuning field 808.

In some embodiments, the method may include an initial step at block 1 of wiring the driver electronics 200 and receiver 120 as depicted in FIG. 2.

At block 2, the method can continue with testing for a reference light characteristic value of a working lighting structure with the detector 110. M ore particularly, the detector 110 being configured for measuring color correlated temperature (CCT) or illuminance (LUX) is positioned underneath a working lighting structure, such as a luminaire. Light may be emitted by the working lighting structure, e.g., luminaire, and that light can be detected by the detector 110, in which the lighting characteristics, such as the color correlated temperature (CCT) or the illuminance (LUX), is recorded, and then set as a reference light characteristic value. The reference light characteristic value can be the characteristic of light that is desired to be replicated when repairing light structures 300, e.g., by replacing worn, damaged or non-functioning driver electronics 200. To detect the characteristics of the light being emitted by the lighting structure 300, the detector 110 is placed within the beams of light being emitted, e.g., under the lighting structure 300, as depicted in FIG. 1. In some embodiments, measuring the reference light characteristic value can begin with measuring the ambient light, e.g., measuring the color correlated temperature (CCT) or measuring the luminance of the ambient light. Measuring the ambient light can be performed by the detector 110. To measure the ambient light, the working lighting structure is turned off so that there is no light being emitted from the working lighting structure. With the working lighting structure turned off, the detector measures the ambient light. Thereafter, following measurement of the ambient light, the working lighting structure is then turned on. With the working lighting structure turned on, the light emitted from the working lighting structure is then measured by the detector 110. This measurement includes both the light from the ambient light, as well as the light that is contributed by the working lighting structure 110, which are both measured by the detector 110. This light may be referred to as the combined lighting structure and ambient light value. To isolate the contribution of the working lighting structure 300, the ambient light is subtracted from the measurement of the combined lighting structure and ambient light value, which provides the reference light characteristic light characteristic value. During measurement of the reference light characteristic value, the positioning of the detector 110 is measured and recorded so that the detector 110 can be similarly positioned for measuring the lighting characteristics of light being emitted by a reference lighting structure that is being commissioned into an existing network or is replacing a lighting structure being repaired.

In some embodiments, the calculations are conducted with the controller 400a, 400b. For example, the calculations may be performed by the light adjustment application 144 of the applications 143 stored in the memory of the mobile computing device 130, as depicted in FIGS. 2 and 7. In other embodiments, the calculations can be conducted at the controller 400a that is integrated into the detector 110, e.g., the light adjustment application 1313,

In some embodiments, before the start test, one optional step is to start the test procedure by other wireless, wired equipment, or a test button that is built into the detector 110 that are configured to facilitating the driver recognizing that the dimming ports are being using in procedures to optically adjust signal, and not for dimmer functionality, as intended during normal operation. During normal operation, which is the functioning of the luminaire to illuminate a room, the DIM+ and DIM−ports of the driver electronics 200 are used to control dimming of the lighting structure 300. During testing operations, the DIM+ and DIM−ports are used in the electrical circuitry in which the current of the driver electronics 200 is cycled to the light engine of the lighting structures so that it can be recorded, and associated to changes in the lighting characteristics accompanying those changes in current, in which the changes in the lighting characteristics are measured by the detector 110. M ore specifically, in some embodiments, in which the driver electronics control current to two different lighting strings having different lighting characteristics, the different DIM+ports can be used to cycle current individually to each of the two lighting strings. By cycling the current to each of the different strings of LEDs, and measuring the resultant light emitted using the detector, the current applied to the different strings of LEDs can be correlated to different light characteristics for the light being emitted by the reference lighting structure. The correlation of current controls of the drive electronics can then be used to adjust the driver electronics for the reference lighting structure to produce the reference light characteristic value of light being emitted by the reference lighting structure.

In some embodiments, finished with the process, a similar operation to the operation that is used to instruct the driver 200 of being used in a testing stage, is done to inform the driver 200 to close the testing stage function, so that the dim ports can be release for dimmer performance commands during operation of the lighting structure 300.

The method may continue to block 3. At block 3, the previously recorded reference light characteristic value is now entered into the detector 110 as the value the calibration device 100 is looking to set in a lighting structure that is being repaired, e.g., is not functioning, is functioning outside a predetermined performance window or is due for maintenance.

Block 4 includes positioning the detector 110 to read the light characteristics of light emitted by a lighting structure that is being configured in response to repair or commissioning. For example, the lighting structure at this stage of the process flow may be one that is being added to an existing network, which is an example of a newly commissioned lighting structure. In another example, the lighting structure at this stage of the process flow is replacing an existing lighting structure that is not functioning, is functioning outside a predetermined performance window or is due for maintenance. The lighting structure that is being configured in response to repair or commissioning may hereafter be referred to as a “reference lighting structure”.

The detector 300 for reading the light characteristics of light to be emitted by the lighting structure that is being commissioned, repaired and/or replaced can be the same detector 300 that is used to record the reference light characteristic value. This provides consistency between the devices used to record the reference light characteristic value from the functioning lighting structure 300, and the device used to set the lighting characteristics for the light emitted by the lighting structure 300 being newly commissioned or repaired.

The detector 110 is positioned under the reference lighting structure in a similar manner to how the detector 110 was positioned for measuring the reference light characteristic value of the light being emitted by the working lighting structure 300. The objective is to position the detector 110 is a manner that emulates the position of the detector for when the reference light characteristic value was recorded. This reduces the amount of variables that can cause the detector 110 to read different readings for the light to be measured from the working lighting structure and the reference lighting structure.

The method can continue at block 5 with connecting the receiver 120 to the driver electronics 200 that are connected to the reference lighting structure 300. The driver electronics 200 that are connected to the reference lighting structure 300 at this stage of the process flow have not been configured. The original current that the driver electronics 200 transmit to the light engine of the lighting structures may be an initial setting. The methods described herein provide a mechanism for how the current of the driver electronics 200 can be adjusted until the light being emitted by the reference lighting structure 300 has lighting characteristics that are equal to the reference light characteristic value. It is noted that the order of blocks 4 and 5 in FIG. 4 can be reversed.

In some embodiments, before light is emitted from the reference lighting structure 300, the ambient lighting that the reference lighting structure is present in is first measured using the detector 110. The ambient lighting that is measured for the reference lighting structure is measured similar to how the ambient lighting structure is measured from the working lighting structure. More specifically, the detector 110 positioned in a manner to measure the light emitted from the reference lighting structure. However, the ambient light is then measured by the detector 110 while the reference lighting structure is off, i.e., no light is being emitted by the light engine of the reference lighting structure 300.

Light is then emitted from the reference lighting structure 300. At block 6 of the method depicted in FIG. 4, the method can continue with measuring the initial lighting characteristics of the reference lighting structure. For example, using the initial electrical performance settings, e.g., initial current values, light is emitted by the reference lighting structure 300 and measured by the detector 110. In some examples, the lighting characteristic measured at this stage of the process flow can be color correlated temperature (CCT) or luminescence (LUX).

The measured initial lighting characteristics of the reference lighting structure are recorded. More septically, in some embodiments, the detector 110 can make a combined measurement of the ambient lighting and the lighting that is produced by the referencing lighting structure. As described above, the ambient lighting may have already been measured and recorded using the same detector 110. Because the ambient lighting is known it can be subtracted from the combined measurement of the ambient lighting and the lighting that is produced by the reference lighting structure to result in a value for the initial lighting characteristics of the reference lighting structure.

Further, the initial setting for the current of the driver electronics 200 can also be known or estimated. In a following process sequence, the initial lighting characteristics of the reference lighting structure 300 is compared to the reference lighting value for the lighting characteristics that was measured from the functioning lighting structure. Further, the initial electrical performance settings, e.g., initial current values, of the driver electronics 200 to the reference lighting structure 300 is also known. Because, the reference lighting characteristics are known, and the initial electrical performance settings of the driver electronics 200 are also known, when the initial lighting characteristics do not match the reference lighting characteristics an adjustment can be made so that the electrical performance settings to the driver electronics can be adjusted so that the resulting light emitted more closely matches the reference lighting characteristics.

More particularly, this process sequence can begin with sending the measured value, i.e., the initial lighting characteristics, to the receiver 120 at block 7. M ore specifically, in some embodiments, the detector 110 will record the CCT value and LUX value for the light emitted by the reference lighting structure 300, then convert that value into a corresponding dimming signal. In some embodiments, following conversion, the converted signal can then be transmitted from the detector 110 to receiver 120, by wireless signal, such as Bluetooth, Wifi, 433 Mhz etc. It is noted that the conversion does not necessarily have to take place at the detector 110. For example, the detector 110 also can also directly send the raw data, i.e., data that has not be converted to converted to correspond for dimming signal, for the CCT measurement and the LUX measurement from the reference lighting structure 300 to receiver 120. Under these circumstances, in which the raw data for the light characteristics, e.g., CCT and LUX, is sent directly to the receiver 120, and the receiver 120 is responsible for conversion of the raw data measurements to a type of data that can be recognized by the driver electronics 200 when entered into the dimming ports, e.g., DIM+ and DIM−.

At this point of the method, the initial electrical performance of the driver electronics 200 and the initial lighting characteristics of the light emitted by the reference light structure is known. Further, the reference lighting characteristics are also known, as the reference lighting characteristics were measured at blocks 1 and 2. If the initial lighting characteristics do not match the reference light structure, the electrical performance, e.g., current applied to the light engine of light emitting diodes (LEDs), of the driver electronics, adjustment in the electrical performance of the driver electronics 200 may be performed to adjust the lighting characteristics from the initial lighting characteristics towards the reference lighting characteristics.

Referring to FIG. 4, in some embodiments, the method may include block 8. Block 8 can include adjusting driver current in an effort to adjust the emitted light from the reference lighting structure 300 from the initial lighting characteristics to the reference light characteristic value. In some embodiments, in which the driver electronics control 200 current to different channels of a multi-channel driver, the current to each of the channels may be modulated through the DIM+ and DIM− connections. The current may be adjusted to each of the channels, i.e., to each string of light emitting diodes in the light engine, so that a different ratio of the current may be sent to each channel for each measurement of light produced by the light engine under those conditions. The current adjustments to the driver electronics, e.g., the different ratio of current sent to each channel of the driver, and the resultant lighting characteristics may be recorded, e.g., recorded in table format. As will be described below, the adjustment of electrical performance, e.g., current to the different channels of the multichannel electronics driver to the separate strings of light emitting diodes (LEDs), may be repeated, and the resulting emitted light recorded, until the light emitted by the reference lightings structure meets the reference lighting characteristic value. Each change in electrical characteristics/electrical performance of the driver electronics 200 and the resulting lighting characteristics of the lighting structure 300 are recorded.

Using the correlation between the modulation of the electrical characteristics of the electrical driver, and the resultant lighting characteristics, electrical driver settings can be determined so that the reference lighting structure can emit light having characteristics equal to the reference lighting value. In some examples, the electrical characteristics being adjusted in the driver electronics is the current ratio to the different strings of light emitting diodes of the light engine that is controlled by the driver electronics. In some examples, the reference lighting characteristic value is a color correlated temperature (CCT). In some other examples, the reference lighting characteristic value is a luminance, e.g., LUX value.

Block 9 includes measuring adjusted lighting characteristics of lighting structure 300 after the current adjustment. The lighting characteristics can be measured by the detector 110, in which the detector 110 is positioned in a substantially identical configuration to the reference lighting structure 300 as when the detector 110 made the previous measurements for the lighting characteristics, e.g., initial lighting characteristics, from the reference lighting structure 300. In some embodiments, additional measurements can be made for the ambient lighting. However, prior ambient lighting measurements can also be employed at this stage of the process flow, so long as the ambient lighting measurements are suitable for characterizing the ambient in which the adjusted lighting performance is being measured.

The data may be recorded in table form and stored in a module of memory for access by the light adjustment application 113 in the controller 400a of the detector 110, as depicted in FIG. 5, or the memory 140 of the mobile computing device 130 for access by the light calibration application 144, as depicted in FIG. 7. In some examples of the mobile computing device 130 may save the data in a current/light characteristic data 145 module of the memory 140.

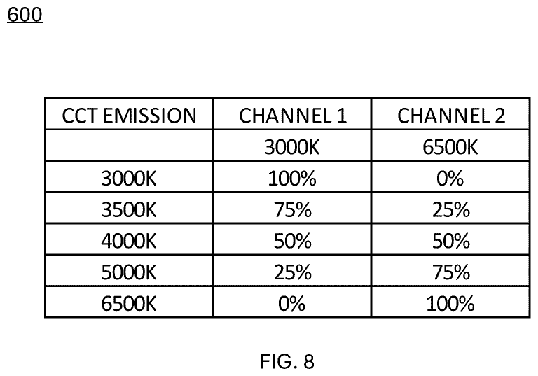

FIG. 8 is a table 600 illustrating mixing of two strings of light emitting diodes having two different color correlated temperatures (CCT), in accordance with one embodiment of the present disclosure. FIG. 8 is a table 600 illustrating how percentages of current can be distributed between to two different strings of light emitting diodes (LEDs) having different color correlated temperatures (CCT), and what the color correlated temperature is for the combined output of these two lights schemes.

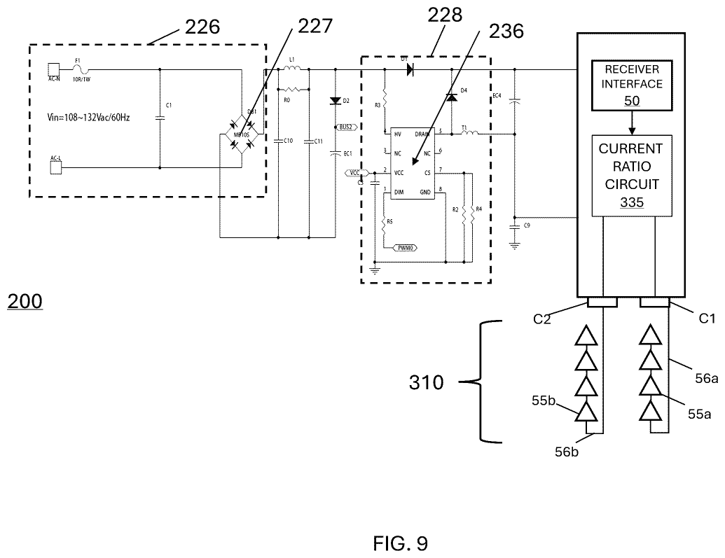

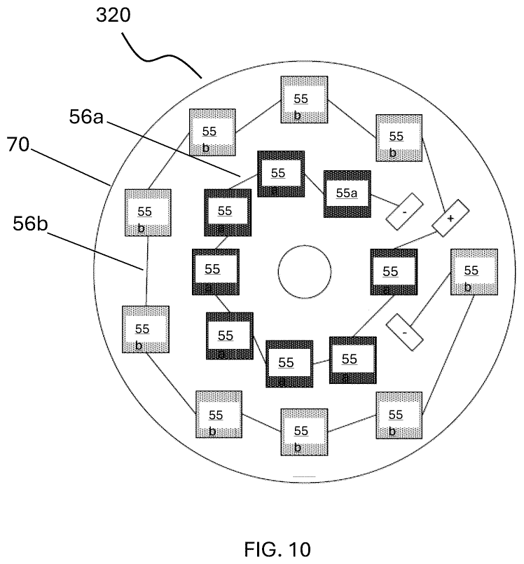

FIG. 9 is a circuit diagram of the multi-channel driver electronics 200 of a lighting structure 300 that includes two channels C1, C2 connected to two different strings 56a, 56b of light emitting diodes 56a, 56b having different lighting characteristics, e.g., different color correlated temperatures (CCT). FIG. 10 is a top down view of a light engine 310 including a plurality of solid state light emitters 55a, 55b providing the light source of a lamp that includes two strings of light emitting didoes (LEDs) 56a, 56b to provide at least two lighting schemes for a light engine as employed in the luminaire illustrated in FIGS. 1 and 6, in accordance with one embodiment of the present disclosure.

The table 600 illustrated in FIG. 8 illustrates one example of how strings of different color correlated temperature (CCT) light emitting diodes (LEDs) can be mixed to provide for adjustability in the light characteristics of a lighting structure housing the two strings of LEDs 56a, 56b as the light engine 20 of the device. In this example, the first string of LEDs 56a is connected to a first channel address (FIRST CHANNEL) C1 for the multi-channel electronics driver 200, and the second string of LEDs 56b is connected to a second channel address (SECOND CHANNEL) C2 for the multi-channel electronics driver 200. The table 600 illustrated in FIG. 8 is one example of how two strings of LEDs 56a, 56b having different light characteristics may be mixed by adjusting the current that is sent to each of the strings of LEDs 56a, 56b independently, i.e., through the separate corresponding channels C1, C2 of the multi-channel electronics driver 200.

Referring to block 10 of FIG. 4, the measured lighting characteristics for the reference lighting structure 300 from block 9 are then compared to the reference value for the lighting characteristics that was measured from block 2. A determination is then made as to whether the light being emitted by the reference lighting structure after the adjustment to the electrical parameters to the driver electronics 300 matches the reference lighting characteristic value. If a match has been achieved, the calibration method may end. The electrical performance that resulted in the reference lighting structure 300 provided the reference lighting characteristic value may then be applied to the driver electronics 200 of the reference lighting structure 300 for use during normal operation of the lighting structure. Light having the reference value may then be emitted from the reference lighting structure 300 at block 11.

However, referring back to block 10, if the light that is emitted by the reference lighting structure 300 following the electrical performance adjustments have been applied to the driver electronics 200 as described in block 8 does not match the reference value, the method may cycle back to block 8. At block 8 another adjustment is applied to adjust the driver electrical parameters to adjust the lighting characteristics towards reference value. As described above, in some embodiments to adjust the electrical parameters, the ratio of current being sent to the different strings of light emitting diodes (LEDs) may be adjusted. In some embodiments, the driver electronics may be multi-channel. Current may be individually set to each channel. Each string of light emitting diodes may have a different lighting performance, such as a different color correlated temperature. The greater the distribution of current to a string of LEDs, the greater the string receiving the greater current contributes to the overall lighting characteristics of light being emitted from a multi string light engine.

Following the second adjustment being applied to the electrical parameters of the driver electronics, the detector 110 again measures the adjusted lighting characteristics of the reference lighting structure after current adjustment, as described with reference to block 9. Continuing to block 10, the method can then continue to determining whether the adjusted lighting characteristics match threshold value. If the adjusted lighting characteristics do not match the threshold value, the method can again repeat the loop including blocks 8, 9 and 10. In some instances, the loop of blocks 8, 9 and 10 may be referred to as an adjustment loop. In some embodiments, the adjustment loop may be repeated until the light emitted by the reference lighting structure matches the reference lighting characteristic value.

In some embodiments, when the light emitted by the reference lighting structure matches the reference lighting characteristic value, the data for this setting may be saved in one or more memory modules on the printed circuit board (PCB), e.g., control board, of the driver electronics 200.

Referring to FIG. 2, in some embodiments, the current/lighting characteristic data 205 may be saved in one or more memory modules on the printed circuit board (PCB), e.g., control board, of the driver electronics 200. It is noted that the electrical performance of the driver electronics 200 and the resultant lighting characteristics may also be saved in the receiver 120, the detector 110, as well as the mobile computing device 130 (where applicable). In some embodiments, when the electrical performance of the driver electronics 200 and the resultant lighting characteristics are saved in the memory of the driver electronics 200 (current/lighting characteristic data 205), the receiver 120, the detector 110, and/or mobile computing device 130 (where applicable), the value can be read during the commissioning/repair of any other lighting structure, in which the saved settings, e.g., the setting saved in the current/lighting characteristic data 205, can be used in the commissioning and/or repair of the other lighting structures, e.g., using wireless transmission.

In some embodiments, when the electrical performance of the driver electronics 200 and the resultant lighting characteristics are saved in the controller 400a, 400b, any newly commissioned driver electronic 200 may be configured to function with those saved settings for the electrical performance that provides the resultant lighting characteristics. Near field communication (NFC) signal may be employed to transmit the settings for the electrical performance of the driver electronics 200 to driver electronics that are being newly commissioned. For example, the controller 400a, 400b, which can be a mobile computing device 130, such as a smart phone, may transmit the driver settings that provide the electrical performed of the driver electronics and the resultant lighting characteristics by bringing the controller 400a, 400b in close proximity to a driver electronics that are being newly commissioned to allow for transfer of the data by NFC signal. For example, the controller 400a, 400b, e.g., mobile computing device 130, may transmit the data to driver electronics being newly commissioned by NFC signal, by tapping the controller 400a, 400b to the driver electronics. For example, tapping includes a momentary physical contact between the controller 400a, 400b and the driver electronics that are being newly commissioned.

Referring to FIG. 6, in some embodiments, the mobile computing device 300 may be provided by a cellular phone including one or more processor for performing the lighting calibration methods described herein. In some embodiments, the mobile computing device 300 may be a mobile phone, such as a smart phone. In some embodiments, employing the mobile phone in combination with the system 100b depicted in FIG. 6 can include pairing the mobile phone (mobile computing device 130) with detector 110 and receiver 120, testing the reference value from a working luminaire 300 by detector 110. In this embodiment, the detector 110 may be positioned right under the luminaire, e.g., lighting structure, while operating the application 144 on mobile phone, e.g., mobile computing device 130, to show the test value to the user on the user interface of the mobile phone, e.g., the graphic user interface 143 of the mobile computing device 130.

As noted, in some embodiments, the receiver 120 is connected to the DIM+/DIM−ports of the driver electronics, as depicted in FIGS. 2, 6 and 7. In some embodiments, the light calibration application 144 of the mobile phone, e.g., mobile computing device 130, can include a function that when the phone is being operated by the user, the light calibration application 144 can send a command to the receiver 120 to instruct the receiver to send a wireless signal to detector 110, in which the command from the receiver 120 indicates that the dimming port, e.g., at least one of DIM+ and DIM−, is preparing for adjusting lighting structure, e.g., luminaire, parameters.

The light calibration application 144 can provide functions so that the user operating the mobile phone, e.g., mobile computing device 130, can record the reference lighting characteristic value for light being emitted from an operational lightings structure 300 using the detector 110. More specifically, the user can position the detector 110 under an operational lighting structure 300, and from the mobile phone, e.g., mobile computing device 130, can record lighting characteristics for the light being emitted from the operational lighting structure 300. Using this mechanism for recording lighting characteristics, block 2 for the method illustrated in FIG. 4 may be performed, i.e., testing for a reference value of a functioning lighting structure with the detector.

The light calibration application 144 can provide functions so that the user operating the mobile phone, e.g., mobile computing device 130, can detect and record the initial lighting characteristics, e.g., CCT value and LUX value, of lighting structure to be configured. For example, after the reference light characteristic value has been set, e.g., measured/recorded by the detector 100, the user can then put the same detector 119 under the reference lighting structure to be newly configured (e.g., keeping the same relative position through which the reference light characteristics was recorded from the functioning lighting structure at block 2 of FIG. 4), the light calibration application 144 can then measuring initial lighting characteristics of lighting structure to be configured, as described in block 6 of FIG. 4.

In some embodiments, the light calibration application 144 of the mobile computing device 130, e.g., mobile phone, then convert the value measured at block 6 of the method described in FIG. 4 into corresponding dimming signal and transmit it to receiver by bluetooth, or other wireless signal. As noted above, the receiver 120 is connected to the DIM+/DIM−ports of the driver electronics 120. Through the DIM+/DIM−port of the driver electronics, the lighting characteristics converted into a DIM+/DIM−signal can be used to adjust the electrical performance of the driver electronics 200 to adjust the light emitted by the lightings structure to have performance equal to the reference lighting characteristic value. In some embodiments, conversion of the lighting characteristic measurements into a DIM+/DIM−signal can be achieved at the detector 110, the receiver 120 and/or the mobile computing device 130, e.g., the mobile phone.

As noted with reference to FIG. 4, from the measurements of the reference lighting characteristics and the initial lighting characteristics of the lighting structure to be configured, adjustments are made for the driver electrical parameters to adjust initial lighting characteristics towards the reference value. This analysis may be conducted by the light calibration application 144, which can include a table of comparative data in a current/lighting characteristics 145 module of memory. One example of the type of data that may be stored in the current/lighting characteristics 145 module that can be stored in the memory 140 of the mobile computing device 130 is the table 600 illustrated in FIG. 8. For example, in some embodiments, by referencing historical data, such as the table 600 of example data illustrated in FIG. 8, the light calibration application 144 can provide parameters for adjustments to the electrical performance of the driver electronics 200 for adjusting lighting parameters from the initial lighting characteristics towards reference lighting characteristic value. In some embodiments, the light calibration application 144 can convert the parameters for adjustments to the electrical performance of the driver electronics to a data type suitable for being received by the dimming ports, e.g., DIM+/DIM−, of the driver electronics 200, or the data can be converted to a type that the driver electronics 200 can recognize.

The light calibration application 144 of the mobile computing device 130 can then send the data to the receiver 120 by wireless signal, e.g,. send the data to the driver electronics through the dimming port, e.g., DIM+/DIM−. The data can be configured in the forms of commands that cause the driver electronics 200 to change their electrical performance, e.g., change current settings being sent to the one or more strings of light emitting diodes (LEDS). In some embodiments, the data conversion may also occur at the receiver 200. This step is consistent with block 7 for the method described in FIG. 4.

The driver electronics can then change the driver electronic performance in response to the commands received from the light calibration application 144 of the mobile computing device 130, e.g., the light calibration application 144 being run on the mobile phone. Further details are provided in the description of block 8 for the method described in FIG. 4.

Similar to how the detector 110 was used to measure the reference lighting characteristic value and the initial lighting characteristics, after the electrical performance of the driver electronics 200 are adjusted, the light calibration application 144 can again use the detector 110 to measure the adjusted lighting characteristics of lighting structure 300, e.g., the adjusted lighting characteristics after current adjustments by the driver electronics 200 to the different strings of light emitting diodes (LEDs) in the light engine 310 of the lighting structure 300.

In some embodiments, until the detector 110 measures a lighting characteristic value that matches the reference lighting characteristic value, or within a reasonable margin of error, the driver electronics 200 can lock the appropriate current values. The light calibration application 144 can then write the value to other memory, such as memory on NFC module, or memory chips on driver board. For example, the light calibration application 144 can store the current values and associated lighting performance in the current/lighting characteristic data module 145 of the memory 140 of the mobile computing device 130, e.g., mobile phone.

Thereafter, the receiver 120 and detector 110 can be removed from the system, and the lighting structures 300 can operate in normal operational settings.

It is noted that the above described embodiments are illustrative and not limiting. For example, an alternative to the systems shown in FIGS. 1, 2 and 6 includes driver electronics 200 having only one dimming port. In the embodiments depicted in FIGS. 1, 2 and 6 there are two dimming ports DIM+. In the embodiment including only a single dimming port DIM+, when the detector 110 and/or mobile device 130 sends measured lighting characteristics, e.g., the CCT and LUC data to receiver 120, a microprocessor control unit (MCU) 206 in the receiver 120 sends a specifically defined adjustment signal to the dimming port (DIM+) of driver electronics 200. In some embodiments, when the driver electronics 200 received these signal from the M CU of the receiver 120, the driver electronics 200 take different actions according different signal.

Referring to FIGS. 1 and 6, when a user connects the driver electronics 200 to a lighting structure 300, and connects the receiver 120 to the driver electronics 200, the AUX and GND ports provide electric power for receiver 120. Further, each DIM+port and DIM−port forms an electrical circuit with the receiver. The embodiments depicted in FIGS. 1 and 6 have two DIM_+ports. However, in some instances, the driver configuration may only have one DIM+port, which is for illuminance dimming information.

One workflow for configuring lighting characteristics in accordance with the methods and systems described herein, and including driver electronics having a single DIM+port, may include the following process flow. The single DIM+port method can begin with getting a reference luminaire output value. For example, the reference value can be tested from a working luminaire by detector 110 as described above, e.g., with reference to blocks 1 and 2 of FIG. 4.

In a following step, a lighting structure 300 that is be configured is prepared to be measured using the detector 110, and is attached to the receiver 120. In this example, there is only on DIM+connection for the receiver 120. However, with the exception of only have one DIM+port, the remaining connections between the receiver 120 and the driver electronics 200 are the same. In this embodiment, before starting the process for configuring the driver electronics for the new light structure, one optional step may include to start the driver's test mode with a dedicated command from other wireless or wired equipment, or push a physical button on driver 200, this step help the driver recognize that the dimming ports are in test mode. Under these conditions, the receiving signal is to configure the driver electronics 200, instead of their intended function for dimming.

In this embodiment, during the test mode, the DIM+port is time division multiplex access, because this method has to configure two channel current information using only one DIM+port. Inn some embodiments, the signal will start with a dedicated command so that driver know which channel should be configured. The signal for selecting which channel to adjust the electrical properties can be sent to the driver electronics 200 from the microprocessor control unit (M CU) 206 in the receiver 120.

In some embodiments, the measurement of the reference lighting characteristic value and the initial lighting characteristic value is similar to the prior embodiment of the present disclosure. However, when the process flow reaches steps for adjusting the electrical performance of the driver electronics 200 for adjusting the light being emitted by the lighting structure, the additional signal identifying which channel of the multi-channel driver electronics 200 is employed to address that the interface for the receiver 120 only includes a single DIM+port. The embodiments of the present embodiment, in which the receiver 120 interfaces with a single DIM+port of a multi-channel driver electronics structure is equally applicable to the embodiments in which the control device 400a is integrated into the detector 110, as depicted in FIG. 1, or when the control device 400b is a separate mobile computing device, such as a mobile phone, e.g., a smartphone running the light calibration application 144.

The present invention may be a system, a method, and/or a computer program product at any possible technical detail level of integration. The computer program product may include a computer readable storage medium (or media) having computer readable program instructions thereon for causing a processor to carry out aspects of the present invention.

For example, the present disclosure provides a computer program product for calibrating lighting, the computer program product comprising a computer readable storage medium having program instructions embodied therewith, the program instructions executable by a processor to cause the processor to: set a reference lighting value; receive lighting characteristics from a light detector measuring a lighting structure provide an initial lighting value; compare, using the processor, the initial lighting value to the reference lighting value using a controller that correlates lighting characteristics to driver electronic electrical performance, wherein the controller provides an adjustment setting in the driver electrical performance to compensate for differences between the reference lighting value and the initial lighting value; send an adjustment signal from the controller to a receiver connected to driver electronics controlling a light engine of the light structure; and adjust light emitted by the lighting structure to correspond to the adjustment signal received at the receiver.

The computer readable storage medium can be a tangible device that can retain and store instructions for use by an instruction execution device. The computer readable storage medium can be non-transitory. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

FIG. 7 is a block diagram of a mobile computing device 130 for setting the lighting characteristics of lighting structures 300, in accordance with one embodiment of the present disclosure.

In one embodiment, the mobile computing device 130, e.g., mobile phone, such as a smart phone, includes a plurality of transceivers in a communications module 148, e.g., an NFC transceiver 151, a WiFi transceiver 150, and a Bluetooth/BLE transceiver 149. The NFC transceiver 151 of the mobile computing device 130 is one mechanism by which the electrical characteristics of driver electronics that have been determined to provide specific lighting characteristics by the calibration device 100a, 100b described herein can be transmitted between the mobile device, e.g., controller 400b, and driver electronics 200 that are being newly commissioned.

The mobile computing device 130 also includes memory 140 that can be used for storing applications 143, such as the light calibration application 144. The light calibration application 144 can provide the functions of the method, as described above with reference to FIG. 4. In some examples of the mobile computing device 130 may also have storage for current/light characteristic data 145 in a module of the memory 140.

The mobile computing device 130 may can employ any of a wide range of computing platforms. In the above description the mobile computing device 130 has been referred to as a mobile phone, e.g., a smartphone. However, the mobile computing device 130 may also be a laptop/notebook computer, sub-notebook computer, a tablet, phablet computer; a personal digital assistant (PDA), a portable media player (PM P), a cellular handset; a handheld gaming device; a gaming platform; a wearable computing device, a body-borne computing device, a smartwatch, smart glasses, smart headgear, and a combination thereof. It is noted that the block diagram that is depicted in FIG. 7 only includes some components that can be incorporated into mobile computing device 130. It is noted that some of the components depicted in FIG. 7 may be omitted, and that some components may be added to the block diagram illustrated in FIG. 7 consistent with the specific type of mobile computing device 130.

The mobile computing device 130 may include memory 140 and one or more processors 330. Memory 140 can be of any suitable type (e.g., RAM and/or ROM, or other suitable memory) and size, and in some cases may be implemented with volatile memory, non-volatile memory, or a combination thereof. A given processor 330 of the mobile computing device 130 may be configured as typically done, and in some embodiments may be configured, for example, to perform operations associated with the mobile computing device 130 and one or more of the modules thereof (e.g., within memory 140 or elsewhere). In some cases, memory 140 may be configured to be utilized, for example, for processor workspace (e.g., for one or more processors 130) and/or to store media, programs, applications, and/or content on the mobile computing device 130 on a temporary or permanent basis.

The one or more modules stored in memory 140 can be accessed and executed, for example, by the one or more processors 330 of the control device 100. In accordance with some embodiments, a given module of memory 140 can be implemented in any suitable standard and/or custom/proprietary programming language, such as, for example C, C++, objective C, JavaScript, and/or any other suitable custom or proprietary instruction sets, as will be apparent in light of this disclosure. The modules of memory 140 can be encoded, for example, on a machine-readable medium that, when executed by one or more processors 330, carries out the functionality of the mobile computing device 130, in part or in whole. The computer-readable medium may be, for example, a hard drive, a compact disk, a memory stick, a server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose-built logic. Some embodiments can be implemented with a microcontroller having Input/Output capability (e.g., inputs for receiving user inputs; outputs for directing other components) and a number of embedded routines for carrying out the device functionality. In a more general sense, the functional modules of memory 140 (e.g., such as operating system (OS) 142, graphic user interface (GUI) 143, and/or one or more applications 143, each discussed below) can be implemented in hardware, software, and/or firmware, as desired for a given reference application or end-use. The memory 140 may include an operating system (OS) 142. The OS 142 can be implemented with any suitable OS, mobile or otherwise, such as, for example, Android OS from Google, Inc.; iOS from Apple, Inc.; BlackBerry OS from BlackBerry Ltd.; Windows Phone OS from Microsoft Corp; Palm OS/Garnet OS from Palm, Inc.; an open source OS, such as Symbian OS; and/or a combination of any one or more thereof. As will be appreciated in light of this disclosure, OS 142 may be configured, for example, to aid with setting lighting characteristics of lighting structures.

In some embodiments, the mobile computing device 130 employing the processors 330 and the instructions stored in the memory 140 is configured to send/receive light settings to/from the light structures. The mobile computing device 130 can also include a display 110. The display 110 can be any electronic visual display or other device configured to display or otherwise generate an image (e.g., image, video, text, and/or other displayable content) therefrom. In some embodiments, the display 110 is a touchscreen display or other touch-sensitive display that can utilize any of a wide range of touch-sensing techniques, such as, for example: resistive touch-sensing; capacitive touch-sensing; surface acoustic wave (SA W) touch-sensing; infrared (IR) touch-sensing; optical imaging touch-sensing; and/or a combination of any one or more thereof. The touch screen display 110 may be configured to detect or otherwise sense direct and/or proximate contact from a user of the control device 100 a finger, stylus, or other suitable implement (which can be collectively referred to as a touch gesture) at a given location of that display 110. The touch screen display 110 may be configured to translate such contact into an electronic signal that can be processed by the control device 100 (e.g., by the one or more processors 130 thereof) and manipulated or otherwise used to trigger a given GUI action. In some cases, a touch-sensitive display 110 may facilitate user interaction with the mobile computing device 130 via the graphic user interface 142 presented by such display 110.

In accordance with some embodiments, the mobile computing device 130 can also include one or more sensors 160. In some embodiments, the motion sensors 164 of the sensors 160 housed within the control device 100 can be used to measure motions applied to the control device 100, which can correlated to commands for changes in lighting characteristics of the luminaires. In some embodiments, the mobile computing device 130 may include other sensors 160, which can include at least one camera 161 (or image capture device), microphone 162 (or sound capture device), ambient light sensor 163, and/or any other suitable sensor to, for example, implement the techniques variously described herein.

In accordance with some embodiments, the mobile computing device 130 (also referred to as mobile computing device) may include one or more loudspeakers 170 or other audio output devices, in accordance with some embodiments. Loudspeaker(s) 170 can be, for example, a speaker or any other device capable of producing sound from an audio data signal, in accordance with some embodiments. As illustrated in FIG. 7, the aforementioned elements of the mobile computing device 130 may be interconnected with a communications bus 105.

FIG. 9 is a circuit diagram of the multi-channel electronics driver 200, which can be used to send different electrical parameters, such as current, to the separate channels of the driver 200, in accordance with one embodiment of the present disclosure. The driver electronics 200 include a channel, e.g., two channels C1, C2, to each of the strings 56a, 56b of LEDs 55a, 55b. Further, the driver electronics 25 may be controlled through the light calibration application 143 of the mobile control device 130 depicted in FIG. 7 or the light adjustment application 113 of the detector 110 depicted in FIG. 5.

The driver electronics 200 include an AC input circuit 226, which includes a rectifying bridge 227. In some embodiments, the Vin=108˜132Vac/60 Hz. The AC input circuit 226 feed AC current into a power supply circuit 228. The power supply circuit 228 includes an analog power supply integrated circuit 236 that delivers constant current to a current ratio setting integrated circuit 335. The light engine 310 including the LEDs 55a, 55b (in some embodiments LED strings 56a, 56b) receives current from the power supply circuit 29 for powering the LEDs 55a, 55b.

The current ratio setting integrated circuit 335 distributes portions of the current to each of the separate channels C1, C2 of the multi-channel electronics driver 200, e.g., to provide independent current to each of the light strings light emitting strings 56a, 56b. The IC that provides the current ratio setting integrated circuit 335 may include a receiver interface 50 for receiving commands for adjusting the current to the separate channels C1, C2 from the receiver 120. The instructions may include how the current received by the current ratio setting integrated circuit 335 from the power supply circuit 228 is distributed to the different lighting arrangements, e.g., different strings of light emitting diodes (LEDs), for light mixing in setting the light characteristics for the collective light being emitted by the light engine 20.

In some embodiments, the multi-channel electronics driver 200 include at least two output channels C1, C2 for controlling current to the at least two lighting schemes, e.g., at least two strings 56a, 56b of light emitting diodes 55a, 55b, as depicted in FIG. 10. In one example, the multi-channel driver electronics 200 that is depicted in FIG. 9 may be provided by a dual channel LED driver for CCT tunable LEDs as manufactured by L.T.F. L.L.C., e.g., 30 W DS30-Wt-0060 from the Dual Channel 700 mΩ Constant current. In one example, the multi-channel electronics driver 200 may be provided by Model Number DS30W700C2043LTLI6-0060 having an input of 12-277V AC, 0.33 A 60 Hz. The wattage for this model number may be 30 W. The output channels include two channels C1, C2 for color mixing. The constant current output may be equal to 700 mA. The load for this model number is 20V to 403 DC LED. The multi-channel electronics driver 200 also allows for adjusting the dimming performance of the device, as well as adjusting the color correlated temperature (CCT) of the light emitted by the light engine 310. For example, Model Number DS30W700C2043LTLI6-0060 available from L.T.F. L.L.C. can provide 0-10V, PWM dimming. It is noted that the above multi-channel electronics driver is only one example of a driver that may be suitable with the structures, systems and methods that are described herein. The present disclosure is not intended to be limited to only this example. Any driver having multiple outputs that can send a separate and independently adjustable current to a string of light emitting diodes for each channel output is suitable for use with the methods and structures described herein.

The multi-channel electronics driver 200 can set a separate current to each of the at least two strings of LEDS 56a, 56b through the plurality of channels C1, C2 to control light characteristics for light being emitted by the light engine 310. The light characteristics that can be adjusted can include color correlated temperature, and lumen output, as well as color, and combinations thereof. In some embodiments, the values for the light characteristic extend from a minimum value to a maximum value through a functionally continuous range. By “functionally continuous” it is meant that the characteristic may be varied with the same range of values as the variability provided by mixing two LED strings through the application of separate currents though each string at the same time for a combined light output. This is distinguished from prior selection methods, which allow for only a few values to be selected for the light characteristics to be emitted by the lighting structure 300.

In some embodiments, the lamp structure includes a multi-channel driver electronics 200 that has two channels C1, C2, as depicted in FIG. 9. For example, each of the lighting schemes 56a, 56b may be a string of LEDs 55a, 55b, in which the LEDs 55a, 55b on the string have a color correlated temperature characteristic for the light emitted by the string of LEDs. Each string of LEDs may be referred to a lighting scheme. The color correlated temperature characteristic is different for each string of LEDs 55a, 55b that provides a lighting scheme 56a, 56b. The LEDs in the string of LED's are connected in series. In some embodiments, the multi-channel electronics driver 25 includes a current ratio circuit for controlling a mixture ratio of the at least two lighting schemes 56a, 56b to provide light emission from the light engine of a selected color correlated temperature (CCT). The different lighting schemes 56a, 56b, e.g., different LED strings 55a, 55b, may each be sent a separate current level. Each of the different lighting schemes 56a, 56b is connected to a separate channel C1, C2 on the multi-channel electronics driver 25. In this example, the mixture ratio is referring to sending different levels of current to the different light schemes 56a, 56b. By adjusting current to each of the light schemes 56a, 56b, the contribution of the individual light schemes color correlated temperature may be modulated to adjust the characteristics of the light emission by the combined light schemes. This is all controlled through the multi-channel driver electronics 200 that includes color correlated temperature (CCT) channel addresses C1, C2 for each of the light schemes 56a, 56b, e.g., light emitting diode (LED) strings 55a. 55b.

The multi-channel electronics driver 25 includes a separate channel C1, C2 for each light scheme 56a, 56b, e.g., to each light emitting diode (LED) string 55a, 55b. For example, if there are two lighting schemes 56a, 56b, e.g., LED strings 55a, 55b, there is a separate channel C1, C2 from the multi-channel electronics driver 25 to each of the two-lighting schemes 56a, 56b, e.g., two LED strings 55a, 55b. This provides that the multi-channel electronics driver 25 can send a different amount of current through each of the different channels C1, C2 that are each connected to a separate light scheme 56a, 56b, e.g., light emitting diode (LED) string 55a, 55b.

For example, if two LED strings 55a, 55b are employed each with different color correlated temperature (CCT) characteristics, the LED string 55a, 55b having the greater amount of current thereto will contribute a greater contribution to the lighting characteristics of the combined light output of both LED strings 55a, 55b. This allow for a range of lighting parameters as possible lighting characteristics to be emitted from the light engine, which depend upon the amount of current being sent to each of the different light stings.

In some embodiments, both channels' C1, C2 outputs are constant currents. For example, the first channel C1 of the multi-channel driver electronics 200 may provide current to a first light scheme 56a, e.g., first light emitting diode string 55a, having a color correlated temperature (CCT) of 3000K; and the second channel C2 of the multi-channel driver electronics 200 may provide current to a second light scheme 56b, e.g., second light emitting diode string 55b, having a color correlated temperature (CCT) of 5000K. In one example, the current may be 300 mA to the first channel C1 that is in communication with an LED string 55a of 3000K; and the current may be 500 mA to the second channel C2 that is in communication with an LED string 55b of 5000K.

In some examples, a color change can be produced using the above described two LED string set up 55a, 55b. For example, when employing a light scheme including the aforementioned two LED strings 55a, 55b of 3000K and 5000K, for the light engine to emit light of only 3000K, the multi-channel driver electronics 200 can send 300 mA of current to the first LED string 55a having the LEDs with the 3000K color correlated temperature (CCT), and can send no current (or an amount of current that is not sufficient to illuminate the LEDs), e.g., 0 mA, to the second LED string 55b having LEDs with the 5000k color correlated (CCT). In another example, when employing a light scheme 56a, 56b including the aforementioned two LED strings 55a, 55b of 3000K and 5000K, for the light engine to emit light of only 5000K, the multi-channel electronics driver 200 can send 300 mA of current to the second LED string 55b having the LEDs with the 5000K color correlated temperature (CCT), and can send no current (or an amount of current that is not sufficient to illuminate the LEDs), e.g., 0 mA, to the first LED string 55a having LEDs with the 3000 k color correlated temperature (CCT).

In yet another example, by adjusting the current to be simultaneously sent to each of the light schemes 56a, 56b at the same time, e.g., to both the first light emitting diode (LED) string 55a having the 3000K color correlated temperature (CCT), and the second light emitting diode (LED) string 55b having the 5000K color correlated temperature (CCT), the combined light emitted by the light engine of the two LED light strings 55a, 55b will emit light that has a color correlated temperature (CCT) value that results from a mixture of the two different LED strings, in which the LED string having the greater amount of current applied thereto make the greater contribution to the color correlated temperature (CCT) produced by the light engine. For example, when the total current to the first LED string 55a of LEDs having a color correlated temperature (CCT) of 3000K is 300 mA, to provide a combined color correlated temperature of 4000K for the light engine of the first LED string 55a of 3000K LEDs and the second LED string 55b of 5000K LEDs, the mixture of current sent to the individual LED string by the multi-channel electronics driver 25 may be approximately 150 mA of current applied to the 3000K LED string 55a and 150 ma of current applied to the 5000K LED string 55b.

The mixing ratio is a measurement of the amount of current to each of the lighting schemes 56a, 56b, e.g., to each of the first and second LED strings 55a, 55b. The mixing ratio may be set by the mixing ratio circuit 335. The mixing ratio circuit 335 may receive commands for adjusting the current to the separate channels C1, C2 from the receiver 120 through the receiver interface 50. For example, if one of the LED strings 55a, 55b was receiving twice the amount of current than the other LED string 55a, 55b, the mixing ratio would be 2:1. By employing multiple lighting schemes 56a, 56b, e.g., multiple LED strings 55a,55b having different color correlated temperature (CCT), a light engine can be provided with adjustable light characteristics, e.g., color correlated temperature ranging from 2700K to 6500K, in which the lighting characteristics may be set through the light calibration application 143 of the mobile control device 130 depicted in FIG. 7 or the light adjustment application 113 of the detector 110 depicted in FIG. 5. It is noted this is only one example. In other examples, the lighting characteristics provided by the multiple lighting schemes 56a, 56b having individually addressable current applications through a multi-channel electronics driver 200 controlled through the light calibration application 143 of the mobile control device 130 depicted in FIG. 7 or the light adjustment application 113 of the detector 110 depicted in FIG. 5, controls the light produced by the light engine to have a color correlated temperature (CCT) ranging from 3000K to 5000K. In one embodiment, in which the light engine includes two strings of light emitting diodes (LEDs) 56a, 56b, e.g., two light emitting diode (LED) strings 55a, 55b, one of the LED strings 55a may have a color correlated temperature (CCT) characteristics for the light that is equal to 3000K, and the second LED string 55b may have a color correlated temperature (CCT) characteristic for the light that is emitted from the light engine that is equal to 5000K. Again, it is noted that this is only one example. In another embodiment, in which the light engine includes two lighting schemes 56a, 56b, e.g., two light emitting diode (LED) strings 55a, 55b, one of the LED strings 55a may have a color correlated temperature (CCT) characteristics for the light that is equal to 2700K, and the second LED string 55b may have a color correlated temperature (CCT) characteristic for the light that is emitted from the light engine that is equal to 5000K.

It is noted that color correlated temperature (CCT) is not the only lighting characteristic that may be controlled by the multi-channel electronics driver 200. For example, the multi-channel electronics driver 200 can also modulate the current that is applied to the lighting schemes 56a, 56b, e.g., the light emitting diode (LED) strings 55a, 55b, for the purposes of increasing or decreasing (e.g., dimming) the light output (e.g., Lux measure) of the light engine. For example, in some embodiments, the dimming or light intensity for the light engine composed of the at least two lighting schemes can provide for adjusting lighting between 100 lux to 1000 lux. For example, lighting for office work may be comfortably done at a value between 250 lux to 500 lux.

Consistent with the above example, in which a color correlated temperature (CCT) of 4000K for light emitted by the light engine is produced by the combination of a 3000K CCT light emitting diode (LED) string and a 5000K CCT light emitting diode (LED) string both receiving a current of 150 mA, to provide for dimming, e.g., dimming to 10%, the multi-channel electronics driver will reduce the current to each of the light emitting diode (LED) strings to approximately 15 mA each.

FIG. 8 is a table 600 illustrating how percentages of current can be distributed between to light schemes 56a, 56b having different color correlated temperatures (CCT), and what the color correlated temperature is for the combined output of these two lights schemes. This is just another example of how strings of different color correlated temperature (CCT) light emitting diodes (LEDs) can be mixed to provide for adjustability in the light characteristics of a lighting structure housing the two lighting schemes 56a, 56b as the light engine 310 of the lighting structure 300. In this example, the first light scheme 56a is connected to a first channel address C1 for the multi-channel electronics driver 200, and the second light scheme 56b is connected to a second channel address C2 for the multi-channel electronics driver 200. The table 600 illustrated in FIG. 8 is one example of how two light schemes 56a, 56b having different light characteristics may be mixed by adjusting the current that is sent to each of the schemes 56a, 56b independently, i.e., through the separate corresponding channels C1, C2 of the multi-channel electronics driver 200.

In the example depicted, the first light scheme 56a that is connected to the first channel address C1 emits light having a color correlated temperature (CCT) of 3000K, and the second light scheme 56b that is connected to the second channel address C2 emits light having a color correlated temperature (CCT) of 6500K. As illustrated in the table, when 0% of the current is sent to the second channel C2, and 100% of the current is sent to the first channel C1, the light emitted by the lighting structure housing the light schemes is equivalent to solely the first channel C1, e.g., 3000K. Similarly, when 0% of the current is sent to the first channel C1, and 100% of the current is sent to the second channel C2, the light emitted by the lighting structure housing the light schemes is equivalent to solely the second channel C2, e.g., 6500K. Mixing of the lighting schemes results in light emitted by the lighting structure having characteristics between the individual values for the first and second lighting schemes connected to the multi-channel electronics driver 25. For example, when 75% of the current for powering the light emitting diodes (LEDs) of the light engine 20 is sent to the first channel C1, and 25% of the current for powering the light emitting diodes (LEDs) of the light engine 20 is sent to the second channel C2, the lighting characteristics for the light emitted by the lighting structure using the two lighting schemes as the light engine will be equal to approximately 3500K. In this example, the color correlated temperature (CCT) of the light emitted by the lighting structure is a mixture of the lighting characteristics of the two lighting schemes, in which the lighting scheme receiving the greater amount of current makes a larger contribution to the lighting performance of the lighting structure. In another example, when 25% of the current for powering the light emitting diodes (LEDs) of the light engine 20 is sent to the first channel C1, and 75% of the current for powering the light emitting diodes (LEDs) of the light engine 20 is sent to the second channel C2, the lighting characteristics for the light emitted by the lighting structure using the two lighting schemes as the light engine will be equal to approximately 5000K. In yet another example, when the current for powering the light emitting diodes (LEDs) of the light engine 20 is sent equally to the first channel C1 and the second channel C2, the lighting characteristics for the light emitted by the lighting structure using the two lighting schemes as the light engine will be equal to approximately 4000K. In the example depicted in the table included in FIG. 8, the total power is 50 Watts. It is noted that this is just another example of how a multi-channel electronics driver 25 can mix separate lightings schemes to adjust the lighting characteristics of the light being emitted therefrom.

FIG. 10 is a top down view of a light engine 310 including a plurality of solid state light emitters providing the light source of a lighting structure 300 that includes two strings of light emitting didoes (LEDs) to provide at least two lighting schemes for a light engine as employed in the luminaire illustrated in FIGS. 1 and 6, in accordance with one embodiment of the present disclosure. The light engine produces light from solid state emitters.

The term “solid state” refers to light emitted by solid-state electroluminescence, as opposed to incandescent bulbs (which use thermal radiation) or fluorescent tubes, which use a low-pressure Hg discharge. Compared to incandescent lighting, solid state lighting creates visible light with reduced heat generation and less energy dissipation. Some examples of solid-state light emitters that are suitable for the methods and structures described herein include inorganic semiconductor light-emitting diodes (LEDs), organic light-emitting diodes (OLED), polymer light-emitting diodes (PLED) or combinations thereof. Although the following description describes an embodiment in which the solid-state light emitters are provided by light emitting diodes, any of the aforementioned solid state light emitters may be substituted for the LEDS.

Referring to FIG. 10, in some embodiments, the light source (also referred to as light engine 310) for the lighting structure 300 is provided by plurality of LEDs 55a, 55b that can be mounted to the circuit board by solder, a snap-fit connection, or other engagement mechanisms. In some examples, the LEDs 55a, 55b are provided by a plurality of surface mount device (SMD) light emitting diodes (LED).

The circuit board 70 for the light engine 310 may be composed of a metal core printed circuit board (MCPB). MCPCB uses a thermally conductive dielectric layer to bond circuit layer with base metal (Aluminum or Copper). In some embodiments, the MCPCB use either Al or Cu or a mixture of special alloys as the base material to conduct heat away efficiently from the LEDs thereby keeping them cool to maintain high efficacy. In some embodiments, other materials, such as FR 4 can also be employed. In some embodiments, the strings of LEDs are mounted on a PCB, which is mounted on inside surface of an optic for the tube lamp 100a.

It is noted that the number of LEDs 55a, 55b on the printed circuit board 70 may vary. The LEDs 55a, 55b are arranged in series connected strings that each provide a lighting scheme 56a, 56. For example, a first set of LEDs 55a are series connected to provide a first string of LEDs that provide the first lighting scheme 56a; while a second set of LEDs 55b are series connected to provide a second string of LEDs that provide the second lighting scheme 56b. As described herein, the first string of the LEDs that provide the first lighting scheme 56a is connected to a separate first channel output C 1 from the multi-channel electronics driver 25 than the second string of LEDs that provide the second lighting scheme 56b which is connected to a second channel output C2. One embodiment of the circuit for the two channel multi-channel electronics driver 25 is depicted in FIG. 9. This provides that the current that is sent to the first string of the LEDs that provides the first lighting scheme 56a is separate from the current that is second string of LEDS that provides the second lighting scheme 56b. Further, the aforementioned example is not intended to be limiting in the number of strings of LEDs, i.e., the number of lighting schemes 56a, 56b, that can be incorporated into the light producing structures that are described herein. For example, although the example depicted includes two LED strings, i.e., two lighting schemes 56a, 56b of LEDs 55a, 55b; the lighting structures described herein are not limited to only this example. For example, the number of LED strings providing different LED lighting schemes may be equal to three, four, five, six, etc. In some examples, the number of LED strings may be equal to the number of channels for the multi-channel electronics driver 25; however, this arrangement is not necessary, as in some examples the number of LED strings may be less than the number of channels on the multi-channel electronics driver 25.

As described above, by modulating current to the different stings, the contribution of the string to the overall light performance can be increased on decreased depending upon the increase or decrease in current sent to the string. A string of LEDS having a greater amount of current sent to it than the other strings of LEDs will have a greater contribution to the lighting performance of the light engine than the string having a lesser amount of current sent to it.

In some examples, the number of LEDs 55a, 55b for each LED string, i.e., lighting scheme 56a, 56b, may range from 5 LEDs to 70 LEDs. In another example, the number of LEDs 55a, 55b may range from 35 LEDs to 45 LEDs. It is noted that the above examples are provided for illustrative purposes only and are not intended to limit the present disclosure, as any number of LEDs 55a, 55b may be present the printed circuit board 70. In some other examples, the number of LEDs 55a, 55b may be equal to 5, 10, 15, 20, 25, 30, 35, 40, 45, 50, 55, 60, 65 and 70, as well as any range of LEDs 55a, 55b with one of the aforementioned examples as a lower limit to the range, and one of the aforementioned examples as an upper limit to the range. In some embodiments, chip on board (COB) light emitting diodes may be used in the light engine.

The LEDs 55a, 55b may be arranged as strings on the printed circuit board 70. When referring to a “string” of LEDs it is meant that each of the LEDs in the string are illuminated at the same time in response to an energizing act, such as the application of electricity from the driving electronics, e.g., driver, in the downlight 100. The LEDs 55a, 55b in a string of LEDs are electrically connected for this purpose. For example, when a string of LEDs 55a, 55b is energized for illumination, all of the LEDs in the string are illuminated. Further, in some embodiments, illuminating the first string of LEDs 55a does not illuminate the LEDs in the second string of LEDs 55b, and vice versa, as they are independently energized by the driving electronics, and not electrically connected. It is also noted that the same LED may be shared by more than one string.

In some embodiments, the LEDs 55a, 55b of the light engine 310 are selected to be capable of being adjusted for the color of the light they emit. The term “color” denotes a phenomenon of light or visual perception that can enable one to differentiate objects. Color may describe an aspect of the appearance of objects and light sources in terms of hue, brightness, and saturation. Some examples of colors that may be suitable for use with the method of controlling lighting in accordance with the methods, structures and computer program products described herein can include red (R), orange (O), yellow (Y), green (G), blue (B), indigo (I), violet (V) and combinations thereof, as well as the numerous shades of the aforementioned families of colors. It is noted that the aforementioned colors are provided for illustrative purposes only and are not intended to limit the present disclosure as any distinguishable color may be suitable for the methods, systems and computer program products described herein.

The LEDs 55a, 55b of the light engine 310 may also be selected to allow for adjusting the “color temperature” (also referred to as the color correlated temperature) of the light they emit. The color temperature of a light source is the temperature of an ideal black-body radiator that radiates light of a color comparable to that of the light source. Color temperature is a characteristic of visible light that has applications in lighting, photography, videography, publishing, manufacturing, astrophysics, horticulture, and other fields. Color temperature is meaningful for light sources that do in fact correspond somewhat closely to the radiation of some black body, i.e., those on a line from reddish/orange via yellow and more or less white to blueish white. Color temperature is conventionally expressed in kelvins, using the symbol K, a unit of measure for absolute temperature. Color temperatures over 5000 K are called “cool colors” (bluish white), while lower color temperatures (2700-3000 K) are called “warm colors” (yellowish white through red). “Warm” in this context is an analogy to radiated heat flux of traditional incandescent lighting rather than temperature. The spectral peak of warm-colored light is closer to infrared, and most natural warm-colored light sources emit significant infrared radiation. The LEDs 55a, 55b of the lamps provided by the present disclosure in some embodiments can be adjusted from 2K to 5K.

The LEDs 55a, 55b of the light engine 310 may also be selected to be capable of adjusting the light intensity/dimming of the light they emit. In some examples, dimming or light intensity may be measured using lumen (LM). In some embodiments, the dimming or light intensity adjustment of the LEDs 50 can provide for adjusting lighting between 100 LM to 2000 LM. In another embodiment, dimming or light intensity adjustment of the LEDs 55a, 55b can provide for adjusting lighting between 500 LM to 1750 LM. In yet another embodiment, the dimming or light intensity adjustment of the LEDs 55a, 55b can provide for adjusting lighting between 700 LM to 1500 LM.

Spatially relative terms, such as “forward”, “back”, “left”, “right”, “clockwise”, “counter clockwise”, “beneath,” “below,” “lower,” “above,” “upper,” and the like, can be used herein for ease of description to describe one element's or feature's relationship to another element(s) or feature(s) as illustrated in the FIGs. It will be understood that the spatially relative terms are intended to encompass different orientations of the device in use or operation in addition to the orientation depicted in the FIGs. Having described preferred embodiments of a LIGHT EMITTING DIODE LIGHTING STRUCTURE WITH INTEGRATED NEAR FIELD COMMUNICATION BASED CONTROLS, it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A calibration system comprising:
a light detector for reading lighting characteristics of a lighting structure;
a receiver for interfacing with driver electronics for controlling current to a light engine of a lighting structure; and
a controller for receiving readings from the light detector for the lighting characteristics of the lighting structure, comparing the light characteristics to a reference light characteristic value, and sending an adjustment signal to the receiver by a wireless signal, the adjustment signal including a current change to the light engine for adjusting the lighting characteristics towards the reference light characteristic value.

2. The calibration system of claim 1, wherein the controller is a mobile computing device.

3. The calibration system of claim 1, wherein the controller is integrated into the light detector.

4. The calibration system of claim 1, wherein the driver electronics include at least two channels to at least two strings of light emitting diodes in the light engine.

5. The calibration system of claim 4, wherein the driver electronics include an interface to at least two DIM+connectors on the driver electronics, the receiver receiving the adjustment signal from the controller, the adjustment signal including commands to adjust current to the at least two channels to the at least two stings of light emitting diodes through the at least two DIM+connectors.

6. The calibration system of claim 1, wherein the lighting structure has a form factor selected from the group consisting of a tube lamp, downlight, lamp bulb and combinations thereof.

7. The calibration system of claim 1, wherein the controller is a mobile computing device, the lighting characteristics measured by the light detector is sent to the controller by a first wireless signal, and the wireless signal by which the controller sends the adjustment signal to the receiver is a second wireless signal.

8. The calibration system of claim 6, wherein at least one of the first wireless signal and the second wireless signal is selected from the group consisting of a WiFi signal, a cellular signal, a near field communication (NFC) signal, a Bluetooth type signal and combinations thereof.

9. The calibration system of claim 1, wherein the detector is selected from the group consisting of tristimulus colorimeter, a spectroradiometer, a spectrophotometer, a spectrocolorimeter, a densitometer, a color temperature meter and combinations thereof.

10. A method of calibrating light:
setting a reference lighting value;
connecting a receiver to driver electronics of a lighting structure including an adjustable light engine;
measuring lighting characteristics from the lighting structure with a light detector to provide an initial lighting value;
comparing the initial lighting value to the reference lighting value using a controller that correlates lighting characteristics to driver electronic electrical performance, wherein the controller provides an adjustment setting in the driver electrical performance to compensate for differences between the reference lighting value and the initial lighting value;
sending the adjustment signal from the controller to the receiver; and
adjusting light emitted by the lighting structure to correspond to the adjustment signal received at the receiver.

11. The method of claim 10, wherein the controller is a mobile computing device.

12. The method of claim 10, wherein the controller is integrated into the light detector.

13. The method of claim 10, wherein the driver electronics include at least two channels to at least two strings of light emitting diodes in the light engine.

14. The method of claim 10, wherein said adjusting the light emitted by the light structure includes adjusting current to the at least two channels of the at least two strings of light emitting diodes in the light engine.

15. The method of claim 14, wherein the driver electronics include an interface to the at least two DIM+connectors on the driver electronics, the connecting of the receiver to the driver electronics includes connecting the receiver to the at least two DIM+connectors.

16. The method of claim 10, wherein the reference lighting value is a measured light characteristic selected from the group consisting of color correlated temperature (CCT), illumination (LUX) and combinations thereof.

17. The method of claim 10, wherein the detector is selected from the group consisting of tristimulus colorimeter, a spectroradiometer, a spectrophotometer, a spectrocolorimeter, a densitometer, a color temperature meter and combinations thereof.

18. The method of claim 10, wherein the reference lighting value is measured from an operating light.

19. The method of claim 11, wherein the adjustment setting in the driver electrical performance is saved in memory of the mobile device, and the adjustment setting is transmitted to additional driver electronics being commissioned through near field communication signal (NFC).

20. A computer program product for calibrating lighting, the computer program product comprising a computer readable storage medium having program instructions embodied therewith, the program instructions executable by a processor to cause the processor to:
setting a reference lighting value;
receiving lighting characteristics from a light detector measuring a lighting structure provide an initial lighting value;
comparing, using the processor, the initial lighting value to the reference lighting value using a controller that correlates lighting characteristics to driver electronic electrical performance, wherein the controller provides an adjustment setting in the driver electrical performance to compensate for differences between the reference lighting value and the initial lighting value;
sending an adjustment signal from the controller to a receiver connected to driver electronics controlling a light engine of the light structure; and
adjusting light emitted by the lighting structure to correspond to the adjustment signal received at the receiver.
